(19) United States
(12) Patent Application Publication
(10) Pub. No.: US 2016/0291205 A1
(43) Pub. Date: Oct. 6, 2016

(54) OPTICAL FILM, POLARIZING PLATE USING OPTICAL FILM, AND IMAGE DISPLAY DEVICE

(71) Applicant: FUJIFILM Corporation, Tokyo (JP)

(72) Inventors: Shusuke ARITA, Kanagawa (JP); Shinya WATANABE, Kanagawa (JP); Kazushige NAKAGAWA, Kanagawa (JP)

(73) Assignee: FUJIFILM Corporation, Tokyo (JP)

(21) Appl. No.: 15/083,889

(22) Filed: Mar. 29, 2016

(30) Foreign Application Priority Data
Mar. 31, 2015 (JP) 2015-074245

(51) Int. Cl. G02B 1/04; G02B 1/14; G02B 5/30; G02F 1/1335

(52) U.S. Cl. CPC G02B 1/04; G02F 1/133528; G02B 1/14; G02B 5/305

(57) ABSTRACT

There is provided an optical film including: a Layer A containing a cyclic olefin-based resin; and a Layer B disposed on at least one surface of the Layer A and containing a cyclic olefin-based resin, wherein the Layer B contains a rubber elastomer having a carbon-carbon double bond that forms no aromatic ring in an amount of 2.5 mass % or more based on a total mass of the Layer B, and a thickness of the Layer B is less than 10 μm.

### CROSS REFERENCE TO RELATED APPLICATION(S)

This application claims priority from Japanese Patent Application No. 2015-074245 filed on Mar. 31, 2015, the entire disclosures of which are incorporated herein by reference.

### BACKGROUND

1. Technical Field

The present invention relates to an optical film, a polarizing plate using the optical film, and an image display device.

2. Related Art

Recently, liquid crystal display devices have been widely used for the use such as televisions, personal computers, mobile phones, and digital cameras. Typically, the liquid crystal display device includes a liquid crystal panel member provided with polarizing plates at both sides of a liquid crystal cell, and display is performed by controlling light from a backlight member to a liquid crystal panel member. Here, the polarizing plate includes a polarizer and at least one optical film as a protective film (a polarizing plate protective film), a general polarizer is obtained by dyeing a stretched polyvinyl alcohol (PVA)-based film with iodine or a dichroic dye, and a film using various thermoplastic resins as the protective film is used.

As the thermoplastic resin film used in the polarizing plate protective film, it has been proposed to use a cyclic olefin-based resin film.

From the fact that the polarizing plate protective film is used as a polarizing plate which is incorporated into a polarizer as described above, adhesive with the polarizer is important, and when the polarizing plate protective film is used as an actual liquid crystal display device, the polarizing plate protective film is in the form where a polarizing plate is joined to a liquid crystal cell, but in this case, in a practical test such as a peeling test of a polarizing plate, it is important for the polarizing plate to be not easily peeled off.

Since the main structure is composed of hydrocarbons and the content of polar substituents is low, the cyclic olefin-based resin has low hygroscopic properties and may be used as a polarizing plate protective film, but is fragile as film characteristics in many cases.

Therefore, Japanese Patent Laid-Open Publication No. 2004-156048 (hereinafter JP-A-2004-156048) and Japanese Patent Laid-Open Publication No. 2005-148567 (hereinafter JP-A-2005-148567) describe that the fragility is improved by adding a rubber elastomer to a cyclic olefin-based resin.

However, the films described in JP-A-2004-156048 and JP-A-2005-148567 generally become incompatible, and thus have concern in that transparency, particularly, the haze as a film is increased, and the internal haze of the film, which is more important in a polarizing plate and a liquid crystal display device, is increased, and have limitations in achieving low haze from the viewpoint of dispersibility particularly during the melt film formation.

Further, when a film is used as a polarizing plate protective film, and brought into contact with a polarizer, there is a problem in that adhesion with the polarizer is low.

An object of the present invention is to provide, as a laminated film having two or more layers including a cyclic olefin-based resin, an optical film which has a low haze, particularly, a low internal haze of the film and is excellent in adhesion with a polarizer when used as a polarizing plate protective film, and a production method thereof. Another object of the present invention is to provide a polarizing plate including the optical film, and an image display device using the polarizing plate.

### SUMMARY

It has been found that the above-described problems may be solved by the following means.

(1) An optical film including: a Layer A containing a cyclic olefin-based resin, and a Layer B disposed on at least one surface of the Layer A and containing a cyclic olefin-based resin, wherein the Layer B contains a rubber elastomer having a carbon-carbon double bond that forms no aromatic ring in an amount of 2.5 mass % or more based on a total mass of the Layer B, and a thickness of the Layer B is less than 10 plm.

(2) The optical film according to (1), wherein the cyclic olefin-based resin contained in the Layer B contains a polymer of a compound represented by the following Formula (I) in an amount of 40 mass % or more based on a total mass of a cyclic olefin-based resin contained in the Layer B:

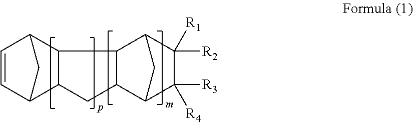

wherein in Formula (I), R₁ to R₄ are a hydrogen atom, a halogen atom, or a monovalent organic group and are each optionally same or different, and two of R₁ to R₄ optionally combine with each other to form a monocyclic or polycyclic structure, m is 0 or a positive integer, and p is 0 or a positive integer.

(3) The optical film according to (2), wherein the polymer of the compound represented by Formula (I) is hydrogenated after ring-opening polymerization of the compound represented by Formula (I).

(4) The optical film according to any one of (1) to (3), wherein the rubber elastomer contains a repeating unit represented by the following Formula (B):

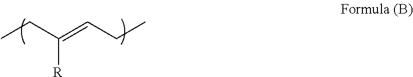

wherein in Formula (B), R represents a hydrogen atom or a methyl group.

(5) The optical film according to any one of (1) to (4), wherein the rubber elastomer is a particle having a core-shell structure.

(6) The optical film according to any one of (1) to (5), wherein the Layer B is disposed on both surfaces of the Layer A.

(7) The optical film according to any one of (1) to (6), wherein the Layer A has a thickness of 2 μm to 90 μm.

(8) A method for producing an optical film, the method including: simultaneously or sequentially film-forming the Layer A and the Layer B by a solution film formation method to prepare the optical film of any one of (1) to (7).

(9) A polarizing plate including the optical film according to any one of (1) to (7) and a polarizer.

(10) The polarizing plate according to (9), wherein the Layer B of the optical film is joined to the polarizer.

(11) An image display device comprising a liquid crystal cell and the polarizing plate according to (9) or (10) disposed on at least one surface of the liquid crystal cell.

According to an aspect of the present invention, it is possible to provide, as a laminated film having two or more layers including a cyclic olefin-based resin, an optical film which has a low haze of the laminated film, particularly, a low internal haze of the laminated film and is excellent in adhesion with a polarizer when used as a polarizing plate protective film, and a production method thereof. Further, it is possible to provide a polarizing plate including the optical film, and an image display device using the polarizing plate.

### DETAILED DESCRIPTION OF EXEMPLARY EMBODIMENTS

Hereinafter, the optical film of an aspect of the present invention, the production method thereof, and the like will be described in detail. The description of the constituent elements described below will be made based on representative embodiments of the present invention, but the present invention is not limited to those embodiments. In addition, the numerical value range expressed by using “to” in the present specification means a range including the numerical values described before and after “to” as the lower limit value and the upper limit value, respectively.

[Optical Film]

The optical film of the present invention is an optical film including:

a Layer A including a cyclic olefin-based resin, and

a Layer B disposed on at least one surface of the Layer A and including a cyclic olefin-based resin,

in which the Layer B contains a rubber elastomer having a carbon-carbon double bond which forms no aromatic ring in an amount of 2.5 mass % or more based on a total mass of the Layer B, and

a thickness of the Layer B is less than 10 μm.

[Cyclic Olefin-Based Resin]

Examples of the cyclic olefin-based resin included in the Layer A and the Layer B of the optical film of the present invention include the following (co)polymers. Alternatively, the cyclic olefin-based resins included in the Layer A and the Layer B may be same or different.

(1) a ring-opening polymer or ring-opening copolymer of a specific monomer represented by the following Formula (I).

(2) a ring-opening copolymer of a specific monomer represented by the following Formula (I) and a copolymerizable monomer.

(3) a hydrogenated (co)polymer of the ring-opening (co)polymer (1) or (2).

(4) a (co)polymer resulting from cyclization of the ring-opening (co)polymer (1) or (2) by a Friedel-Crafts reaction, and then hydrogenation.

(5) a saturated copolymer of a specific monomer represented by the following Formula (I) and an unsaturated double bond-containing compound.

(6) an addition type (co)polymer of at least one monomer selected from a specific monomer represented by the following Formula (1), a vinyl-based cyclic hydrocarbon-based monomer and a cyclopentadiene-based monomer, and a hydrogenated (co)polymer thereof.

(7) an alternating copolymer of a specific monomer represented by the following Formula (I) and an acrylate.

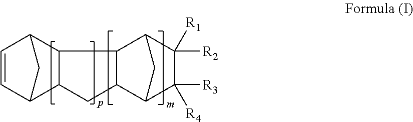

In Formula (I), R₁ to R₄ are a hydrogen atom, a halogen atom, or a monovalent organic group, and may be same or different. Further, two of R₁ to R₄ may combine with each other to form a monocyclic or polycyclic structure. m is 0 or a positive integer, and p is 0 or a positive integer.

Examples of the monovalent organic group represented by R₁ to R₄ include a hydrocarbon group having 1 to 30 carbon atoms, or other monovalent organic groups.

<Specific Monomer>

Specific examples of the specific monomer represented by Formula (I) include the following compounds, but the present invention is not limited to the specific examples thereof.

Examples thereof include bicyclo[2.2.1]hept-2-ene, tricyclo[4.3.0.1^{2,5}]-3-decene, tricyclo[4.4.0.1^{2,5}]-3-undecene, tetracyclo[4.4.0.1^{2,5}.1^{7,10}]-3-dodecene, pentacyclo[6.5.1.1^{3,6}.0^{2,7}.0^{9,13}]-4-pentadecene, 5-methylbicyclo[2.2.1]hept-2-ene, 5-ethylbicyclo[2.2.1]hept-2-ene, 5-methoxycarbonylbicyclo[2.2.1]hept-2-ene, 5-methyl-5-methoxycarbonylbicyclo[2.2.1]hept-2-ene, 5-cyanobieyclo[2.2.1]hept-2-ene, 8-methoxycarbonyltetracyclo[4.4.0.1^{2,5}.1^{7,10}]-3-dodecene, 8-ethoxycarbonyltetracyclo[4.4.0.1^{2,5}.1^{7,10}]-3-dodecene, 8-n-propoxycarbonyltetracyclo[4.4.0.1^{2,5}.1^{7,10}]-3-dodecene, 8-isopropoxycarbonyltetracyclo[4.4.0.1^{2,5}.1^{7,10}]-3-dodecene, 8-n-butoxycarbonyltetracyclo[4.4.0.1^{2,5}.1^{7,10}]-3-dodecene, 8-methyl-8-methoxycarbonyltetracyclo[4.4.0.1^{2,5}.1^{7,10}]-3-dodecene, 8-methyl-8-ethoxycarbonyltetracyclo[4.4.0.1^{2,5}.1^{7,10}]-3-dodecene, 8-methyl-8-n-propoxycarbonyltetracyclo[4.4.0.1^{2,5}.1^{7,10}]-3-dodecene, 8-methyl-8-isopropoxycarbonyltetracyclo[4.4.0.1^{2,5}.1^{7,10}]-3-dodecene, 8-methyl-8-n-butoxycarbonyltetracyclo[4.4.0.1^{2,5}.1^{7,10}]-3-dodecene, 5-ethylidenebicyclo[2.2.1]hept-2-ene, 8-ethylidenetetracyclo[4.4.0.1^{2,5}.1^{7,10}]-3-dodecene, 5-phenylbicyclo[2.2.1]hept-2-ene, 8-phenyltetracyclo[4.4.0.1^{2,5}.1^{7,10}]-3-dodecene, 5-fluorobicyclo[2.2.1]hept-2-ene, 5-fluoromethylbicyclo[2.2.1]hept-2-ene, 5-trifluoromethylbicyclo[2.2.1]hept-2-ene, 5-pentafluoroethylbicyclo[2.2.1]hept-2-ene, 5,5-difluorobicyclo[2.2.1]hept-2-ene, 5,6-difluorobicyclo[2.2.1]hept-2-ene, 5,5-bis(trifluoromethyl)bicyclo[2.2.1]hept-2-ene, 5,6-bis(trifluoromethyl)bicyclo[2.2.1]hept-2-ene, 5-methyl-5-trifluoromethylbicyclo[2.2.1]hept-2-ene, 5,5,6-trifluorobicyclo[2.2.1]hept-2-ene, 5,5,6-tris(fluoromethyl)bicyclo[2.2.1]hept-2-ene, 5,5,6,6-tetrafluorobicyclo[2.2.1]hept-2-ene, 5,5,6,6-tetrakis(trifluoromethyl)bicyclo[2.2.1]hept-2-ene, 5,5-difluoro-6,6-bis(trifluoromethyl)bicyclo[2.2.1]hept-2-ene, 5,6-difluoro-5,6-bis(trifluoromethyl)bicyclo[2.2.1]hept-2-ene, 5,5,6-trifluoro-5-trifluoromethylbicyclo[2.2.1]hept-2-ene, 5-fluoro-5-pentafluoroethyl-6,6-bis(trifluoromethyl)bicyclo[2.2.1]hept-2-ene, 5,6-difluoro-5-heptafluoro-iso-propyl-6-trifluoromethylbicyclo[2.2.1]hept-2-ene, 5-chloro-5,6,6-trifluorobicyclo[2.2.1]hept-2-ene, 5,6-difluoro-5,6-bis(trifluoromethyl)bicyclo[2.2.1]hept-2-ene, 5,5,6-trifluoro-6-trifluoromethoxybicyclo[2.2.1]hept-2-ene, 5,5,6-trifluoro-6-heptafluoropropoxybicyclo[2.2.1]hept-2-ene, 8-fluorotetracyclo[4.4.0.1^{2,5}.1^{7,10}]-3-dodecene, 8-fluoromethyltetracyclo[4.4.0.1^{2,5}.1^{7,10}]-3-dodecene, 8-difluoromethyltetracyclo[4.4.0.1^{2,5}.1^{7,10}]-3-dodecene, 8-trifluoromethyltetracyclo[4.4.0.1^{2,5}.1^{7,10}]-3-dodecene, 8-pentafluoroethyltetracyclo[4.4.0.1^{2,5}.1^{7,10}]-3-dodecene, 8,8-difluorotetracyclo[4.4.0.1^{2,5}.1^{7,10}]-3-dodecene, 8,9-difluorotetracyclo[4.4.0.1^{2,5}.1^{7,10}]-3-dodecene, 8,8-bis(trifluoromethyl)tetracyclo[4.4.0.1^{2,5}.1^{7,10}]-3-dodecene, 8,9-bis(trifluoromethyl)tetracyclo[4.4.0.1^{2,5}.1^{7,10}]-3-dodecene, 8-methyl-8-trifluoromethyltetracyclo[4.4.0.1^{2,5}.1^{7,10}]-3-dodecene, 8,8,9-trifluorotetracyclo[4.4.0.1^{2,5}.1^{7,10}]-3-dodecene, 8,8,9-tris(trifluoromethyl)tetracyclo[4.4.0.1^{2,5}.1^{7,10}]-3-dodecene, 8,8,9,9-tetrafluorotetracyclo[4.4.0.1^{2,5}.1^{7,10}]-3-dodecene, 8,8,9,9-tetrakis(trifluoromethyl)tetracyclo[4.4.0.1^{2,5}.1^{7,10}]-3-dodecene, 8,8-difluoro-9,9-bis(trifluoromethyl)tetracyclo[4.4.0.1^{2,5}.1^{7,10}]-3-dodecene, 8,9-difluoro-8,9-bis(trifluoromethyl)tetracyclo[4.4.0.1^{2,5}.1^{7,10}]-3-dodecene, 8,8,9-trifluoro-9-trifluoromethyltetracyclo[4.4.0.1^{2,5}.1^{7,10}]-3-dodecene, 8,8,9-trifluoro-9-trifluoromethoxytetracyclo[4.4.0.1^{2,5}.1^{7,10}]-3-dodecene 8,8,9-trifluoro-9-pentafluoropropoxytetracyclo[4.4.0.1^{2,5}.1^{7,10}]-3-dodecene, 8-fluoro-8-pentafluoroethyl-9,9-bis(trifluoromethyl)tetracyclo[4.4.0.1^{2,5}.1^{7,10}]-3-dodecene, 8,9-difluoro-8-heptafluoro iso-propyl-9-trifluoromethyltetracyclo-[4.4.0.1^{2,5}.1^{7,10}]-3-dodecene, 8-chloro-8,9,9-trifluorotetracyclo[4.4.0.1^{2,5}.1^{7,10}]-3-dodecene, 8,9-dichloro-8,9-bis(trifluoromethyl)tetracyclo[4.4.0.1^{2,5}.1^{7,10}]-3-dodecene, 8-(2,2,2-trifluoroethoxycarbonyl)tetracyclo[4.4.0.1^{2,5}.1^{7,10}]-3-dodecene, 8-methyl-8-(2,2,2-trifluoroethoxycarbonyl)tetracyclo[4.4.0.1^{2,5}.1^{7,10}]-3-dodecene, and the like.

These may be used either alone or in combination of two or more thereof.

Among the specific monomers, in Formula (1), those in which R₁ and R₃ represent a hydrogen atom or a hydrocarbon group having 1 to 10 carbon atoms, more preferably a hydrocarbon group having 1 to 4 carbon atoms, and particularly preferably a hydrocarbon group having 1 to 2 carbon atoms, R₂ and R₄ represents a hydrogen atom or a monovalent organic group, at least one of R₂ and R₄ represents a polar group having polarity other than a hydrogen atom and a hydrocarbon group, m represents an integer of 0 to 3, p represents an integer of 0 to 3, more preferably m+p=0 to 4, more preferably m+p=0 to 2, and particularly preferably, m=1 and p=0 are preferred. The specific monomer in which m=1 and p=0 is preferred in that the glass transition temperature of the cyclic olefin-based resin obtained is high and the mechanical strength is also excellent.

Examples of the polar group of the specific monomer include a carboxyl group, a hydroxyl group, an alkoxycarbonyl group, an allyloxycarbonyl group, an amino group, an amide group, a cyano group, and the like, and these polar groups may be bonded via a linking group such as a methylene group. Furthermore, examples of the polar group also include hydrocarbon groups in which a divalent organic group having polarity, such as a carbonyl group. an ether group, a silyl ether group, a thioether group, and an imino group may be bonded via a linking group, and the like. Among them, a carboxyl group, a hydroxyl group, an alkoxycarbonyl group, or an allyloxycarbonyl group is preferred, and an alkoxycarbonyl group or an allyloxycarbonyl group is particularly preferred.

Further, the monomer in which at least one of R₂ and R₄ is a polar group represented by Formula —(CH₂)ₙCOOR₅ is preferred in that the cyclic olefin-based resin obtained is set to have a high glass transition temperature and low hygroscopic properties. In the formula depending on the aforementioned specific polar group, R₅ is a hydrocarbon group having 1 to 12 carbon atoms, more preferably 1 to 4 carbon atoms, and particularly preferably 1 and 2 carbon atoms, and is preferably an alkyl group. Further, n is typically 0 to 5, but a small value of n is preferred because the cyclic olefin-based resin has a high glass transition temperature, and in addition, a specific monomer in which n is 0 is preferred in that the synthesis thereof is easy.

Furthermore, in Formula (1), R₁ or R₃ is preferably an alkyl group, more preferably an alkyl group having 1 to 4 carbon atoms, even more preferably an alkyl group having 1 to 2 carbon atoms, and particularly preferably a methyl group, and in particular, it is preferred that this alkyl group is bonded to the same carbon atom as a carbon atom to which a specific polar group represented by the formula —(CH₂)ₙCOOR₅ is bonded in that the hygroscopic properties of the cyclic olefin-based resin obtained may be decreased.

A specific monomer constituting the cyclic olefin-based resin is preferably a compound represented by the following Formula (F).

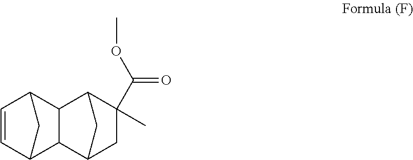 [SMILES: COC(=O)C1(C)CC2CC1C1C3C=CC(C3)C21]

When the specific monomer is the compound represented by Formula (F), m=1 and p=0 in Formula (I), as described above, so that the cyclic olefin-based resin obtained has a high glass transition temperature and an excellent mechanical strength. Further, since the specific monomer is a monomer in which at least one of R₂ and R₄ in Formula (I) is a polar group represented by Formula —(CH₂)ₙCOOR₅, the cyclic olefin-based resin obtained is set to have a high glass transition temperature and low hygroscopic properties. In addition, since n of the polar group represented by —(CH₂)ₙCOOR₅ is 0, the glass transition temperature of the cyclic olefin-based resin obtained is further increased, and the synthesis thereof becomes easy.

Furthermore, as a polymer in which the specific monomer is the compound represented by Chemical Formula (F), a polymer of the compound represented by Formula (F) is more preferably the polymer represented by (3), that is, a polymer to which hydrogen is added after the ring-opening polymerization.

Hereinafter, the monomers, the polymers, and the compounds described in (1) to (7) will be described in more detail.

<Copolymerizable Monomer>

Specific examples of the copolymerizable monomer include cycloolefins such as cyclobutene, cyclopentene, cycloheptene, cyclooctane, dicyclopentadiene, tetracyclododecane, and methanotetrahydrofluorene.

The number of carbon atoms of the cycloolefin is preferably 4 to 20, and more preferably 5 to 12. These may be used either alone or in combination of two or more thereof.

<Ring-Opening (Co)Polymer>

(Ring-Opening Copolymer)

In the present invention, the ring-opening polymerization for obtaining (1) a ring-opening polymer of a specific monomer, and (2) a ring-opening copolymer of a specific monomer and a copolymerizable monomer is conducted in the presence of a methathesis catalyst.

The metathesis catalyst is a catalyst composed of a combination of (a) at least one selected from compounds of W, Mo and Re, and (b) compounds of Group IA elements (for example, Li, Na, K, and the like), Group IIA elements (for example, Mg, Ca, and the like), Group IIB elements (for example, Zn, Cd, Hg, and the like), Group IIIA elements (for example, B, Al, and the like), Group IVA elements (for example, Si, Sn, Pb, and the like), or Group IVB elements (for example, Ti, Zr, and the like) of the Deming's periodic table, the compounds each having at least one element-carbon bond or element-hydrogen bond. Further, in this case, an additive (c) to be described below may be added to the catalyst in order to enhance catalytic activity.

Representative examples of the compounds of W, Mo or Re suitable for component (a) include compounds, such as WCl₆, MoCl₆ and ReOCl₃, described in Japanese Patent Laid-Open Publication No. H1-132626, from lower left column, line 6 of page 8 to upper right column, line 17 of page 8.

Specific examples of components (b) include compounds, such as n-C₄H9Li, (C₂H₅)₃Al, (C₂H₅)₂AlCl, (C₂H₅)_{1.5}AlCl_{1.5}, (C₂H₅)AlCl₂, methylalmoxane, and LiH, described in Japanese Patent Laid-Open Publication No. H1-132626, from upper right column, line 18 of page 8 to lower right column, line 3 of page 8.

Representative examples of components (c), the additives, which may be suitably used, include alcohols, aldehydes, ketones and amines, but it is possible to use compounds described in Japanese Patent Laid-Open Publication No. H1-132626, from lower right column, line 16 of page 8 to upper left column, line 17 of page 9.

The metathesis catalyst is used in such an amount as to give a molar ratio of the aforementioned component (a) to the specific monomers “component (a): specific monomers” of usually 1:500 to 1:50,000, and preferably 1:1,000 to 1:10,000.

The ratio of component (a) to component (b) ((a):(b)) is in a range of 1:1 to 1:50, and preferably 1:2 to 1:30 as a metal atom ratio.

The ratio of component (a) to component (c) ((a):(c)) is in a range of 0.005:1 to 15:1, and preferably 0.05:1 to 7:1 as a molar ratio.

(Solvents for Polymerization Reaction)

Examples of solvents used in the ring-opening polymerization reaction (solvents constituting molecular weight modifier solutions, solvents for the specific monomers and/or metathesis catalysts) include, for example, alkanes such as pentane, hexane, heptane, octane, nonane and decane, cycloalkanes such as cyclohexane, cycloheptane, cyclooctane, decalin and norbornane, aromatic hydrocarbons such as benzene, toluene, xylene, ethylbenzene and cumene, alkane halide or aryl halide compounds such as chlorobutane, bromohexane, methylene chloride, dichloroethane, hexamethylene dibromide, chlorobenzene, chloroform and tetrachloroethylene, saturated carboxylic acid esters such as ethyl acetate, n-butyl acetate, iso-butyl acetate, methyl propionate and dimethoxyethane, ethers such as dibutyl ether. tetrahydrofuran and dimethoxyethane, and the like, and these may be used either alone or in mixture. Among them, the aromatic hydrocarbons are preferred.

The solvent is used in such an amount as to give “a solvent: specific monomers (mass ratio)” of usually 1:1 to 10:1, preferably from 1:1 to 5:1.

(Molecular Weight Modifiers)

Although the molecular weight of the ring-opening (co)polymer obtained may be adjusted according to polymerization temperature, the kind of catalyst and the kind of solvent, the molecular weight is adjusted by allowing a molecular weight modifier to coexist in a reaction system.

Here, examples of a suitable molecular weight modifier include, for example, α-olefins such as ethylene, propene, 1-butene, I-pentene, 1-hexene, 1-heptene, 1-octene, 1-nonene and 1-decene, and styrene, and among them, 1-butene and 1-hexene are particularly preferred.

These molecular weight modifiers may be used either alone or in mixture of two or more thereof.

The amount of the molecular weight modifier used is 0.005 mol to 0.6 mol, preferably 0.02 mol to 0.5 mol, per mol of specific monomer provided in the ring-opening polymerization reaction.

In order to obtain the ring-opening copolymer (2), the specific monomers and the copolymerizable monomer may be copolymerized by ring opening in a ring-opening polymerization process, but the specific monomers may be polymerized by ring opening in the presence of an unsaturated hydrocarbon-based polymer including two or more carbon-carbon double bonds in the main chain such as a conjugated diene compound such as polybutadiene and polyisoprene, a styrene-butadiene copolymer, an ethylene-non-conjugated diene copolymer or polynorbornene.

Although the ring-opening (co)polymer obtained as described above is used as such, (3) a hydrogenated (co)polymer obtained by further hydrogenation is useful as a raw material for a resin having high impact resistance.

<Hydrogenated (Co)Polymer>

(Hydrogenation Catalyst)

The hydrogenation reaction is conducted by a typical method, that is, by adding a hydrogenation catalyst to a solution of the ring-opening copolymer, and allowing a hydrogen gas of normal pressure to 300 atm, preferably 3 atm to 200 atm to act thereon at 0° C. to 200° C., preferably 20° C. to 180° C.

As the hydrogenation catalyst, it is possible to a hydrogenation catalyst used in the hydrogenation reaction of typical olefinic compounds. Examples of the hydrogenation catalysts include heterogeneous catalysts and homogeneous catalysts.

Examples of the heterogeneous catalysts include solid catalysts in which noble metal catalytic materials such as palladium, platinum, nickel, rhodium and ruthenium are carried on carriers such as carbon, silica, alumina and titania. Further, examples of the homogeneous catalysts include nickel naphthenate/triethylaluminum, nickel acetylacetonate/triethylaluminum, cobalt octenoate/n-butyllithium, titanocene dichloride/diethylaluminum monochloride, rhodium acetate, chlorotris(triphenylphosphine)rhodium, dichlorotris(triphenylphosphine)ruthenium, chlorohydrocarbonyltris(triphenylphosphine)ruthenium, dichlorocarbonyltris(triphenyl-phosphine)ruthenium, and the like. The catalysts may be either in a powdery form or in a particulate form.

These hydrogenation catalysts are used in such an amount as to give a ring-opening (co)polymer:hydrogenation catalyst ratio (mass ratio) of 1:1×10⁻⁶ to 1:2.

As described above, the hydrogenated (co)polymers obtained by hydrogenation have excellent heat stability, and their characteristics do not deteriorate even by heating at the time when the hydrogenated (co)polymers are molded, or when the hydrogenated (co)polymers are used as products. Here, the hydrogenation rate is usually 50% or more, preferably 70% or more, and more preferably 90% or more.

In addition, as the hydrogenation rate of the hydrogenated (co)polymer, the value measured at 500 MHz by ¹H-NMR is 50% or more, preferably 90% or more, more preferably 98% or more, and most preferably 99% or more. The higher the hydrogenation rate is, the better the stability to heat or light is, and when the optical film of the present invention is used as a wavelength plate, stable characteristics may be obtained over a long period of time.

Alternatively, for the hydrogenated (co)polymer used as the cyclic olefin-based resin of the present invention, the content of the gel included in the hydrogenated (co)polymer is preferably 5 mass % or less, and particularly preferably 1 mass % or less.

Furthermore, as the cyclic olefin-based resin of the present invention, it is also possible to use (4) a (co)polymer resulting from cyclization of the ring-opening (co)polymer (1) or (2) by a Friedel-Crafts reaction, and then hydrogenation.

<(Co)Polymer Resulting from Cyclization by Friedel-Crafts Reaction, and then Hydrogenation>

(Cyclization by Friedel-Crafts Reaction)

The method for cyclizing the ring-opening (co)polymer (1) or (2) by a Friedel-Crafts reaction is not particularly limited, but it is possible to employ a publicly known method using an acid compound described in Japanese Patent Laid-Open Publication No. S50-154399. As the acid compound, specifically, Lewis acid, such as AlCl₃, BF₃, FeCl₃, Al₂O₃, HCl, CH₃ClCOOH, zeolite or activated clay, or Brønsted acid is used.

The cyclized ring-opening (co)polymer may be hydrogenated in the same manner as in the ring-opening (co)polymer (1) or (2).

Further, as the cyclic olefin-based resin of the present invention, (5) a saturated copolymer of the specific monomer and an unsaturated double bond-containing compound may also be used.

<Unsaturated Double Bond-Containing Compounds>

Examples of the unsaturated double bond-containing compounds include, for example, olefin-based compounds having preferably 2 to 12 carbon atoms, and more preferably 2 to 8 carbon atoms, such as ethylene, propylene and butene.

The range of specific monomers/unsaturated double bond-containing compound used is preferably 90/10 to 40/60, and more preferably from 85/15 to 50/50, by mass ratio.

In the present invention, a typical addition polymerization method may be used in order to obtain (5) the saturated copolymer of the specific monomers and the unsaturated double bond-containing compound.

(Addition Polymerization Catalysts)

As a catalyst for synthesizing the aforementioned saturated copolymer (5), there are used at least one selected from a titanium compound, a zirconium compound and a vanadium compound, and an organic aluminum compound as a promoter.

Here, examples of the titanium compounds include titanium tetrachloride, titanium trichloride, and the like, and example of the zirconium compounds include bis(cyclopentadienyl)zirconium chloride, bis(cyclopentadienyl)zirconium dichloride, and the like.

In addition, as the vanadium compounds,

there are used vanadium compounds represented by Formula: VO(OR)aXb, or V(OR)cXd

[wherein R is a hydrocarbon group, X is a halogen atom, 0≦a≦3, 0≦b≦3, 2≦(a+b)≦3, 0≦c≦4, 0≦d≦4, and 3≦(c+d)≦4.] or electron-donor adducts thereof.

Examples of the electron donors include oxygen-containing electron donors, such as alcohol, phenols, ketone, aldehyde, carboxylic acid, ester of organic acid or inorganic acid, ether, acid amide, acid anhydride and alkoxysilane; and nitrogen-containing electron donors, such as ammonia, amine, nitrile and isocyanate.

Further, as the organic aluminum compound as a promoter, there is used at least one selected from compounds each having at least one aluminum-carbon bond or aluminum-hydrogen bond.

In the above, for example, when the vanadium compound is used, as for the ratio of the organic aluminum compound to the vanadium compound, the ratio of aluminum atoms to vanadium atoms (Al/V) is 2 or more, preferably in a range of 2 to 50, and particularly preferably in a range of 3 to 20.

As solvents for the polymerization reaction used in addition polymerization, the same solvents as used in the ring-opening polymerization reaction may be used. In addition, the molecular weight of the resulting saturated copolymer (5) is adjusted usually by using hydrogen.

Furthermore, as the cyclic olefin-based resin of the present invention, it is also possible to use (6) an addition type copolymer of at least one monomer selected from the specific monomer, a vinyl-based cyclic hydrocarbon-based monomer or a cyclopentadiene-based monomer, and a hydrogenated (co)polymer thereof.

<Vinyl-Based Cyclic Hydrocarbon-Based Monomers>

Examples of the vinyl-based cyclic hydrocarbon-based monomer include vinylated 5-membered hydrocarbon-based monomers including vinylcyclopentene-based monomers such as 4-vinylcyclopentene and 2-methyl-4-isopropenylcyclopentene, and vinylcyclopentane based monomers such as 4-vinylcyclopentane and 4-isopropenylcyclopentane; vinylcyclohexene-based monomers such as 4-vinylcyclohexene, 4-isopropenylcyclohexene, 1-methyl-4-isopropenylcyclohexene, 2-methyl-4-vinylcyclohexene, and 2-methyl-4-isopropenylcyclohexene; vinylcyclohexane-based monomers such as 4-vinylcyclohexane and 2-methyl-4-isopropenylcyclohexane; styrene-based monomers such as styrene, α-methylstyrene, 2-methylstyrene, 3-methylstyrene, 4-methylstyrene, 1-vinylnaphthalene, 2-vinylnaphthalene, 4-phenylstyrene, and p-methoxystyrene; terpene based monomers such as d-terpene, 1-terpene, diterpene, d-limonene, 1-limonene, and dipentene; vinylcycloheptene-based monomers such as 4-vinylcycloheptene and 4-isopropenylcycloheptene; vinylcycloheptane-based monomers such as 4-vinylcycloheptane and 4-isopropenylcycloheptane, and the like.

Among them, styrene and α-methylstyrene are preferred. These may be used either alone or in combination of two or more thereof.

<Cyclopentadiene-Based Monomer>

Examples of the cyclopentadiene based monomer which is used in the monomer of the addition type copolymer (6) of the present invention include cyclopentadiene, 1-methylcyclopentadiene, 2-methylcyclopentadiene, 2-ethylcyclopentadiene, 5-methylcyclopentadiene, 5,5-methylcyclopentadiene, and the like. Among them, cyclopentadiene is preferred. These may be used either alone or in combination of two or more thereof.

The aforementioned addition type (co)polymer of one or more monomers selected from a specific monomer, a vinyl-based cyclic hydrocarbon-based monomer and a cyclopentadiene-based monomer may be obtained in the same addition polymerization method as in (5) the aforementioned saturated copolymer of a specific monomer and an unsaturated double bond-containing compound.

Further, the hydrogenated (co)polymer of the aforementioned addition type (co)polymer may be obtained by the same hydrogenation method as in the aforementioned hydrogenated (co)polymer of (3) the ring-opening (co)polymer.

In addition, as the cyclic olefin-based resin of the present invention, (7) the alternating copolymer of the specific monomer and the acrylate may also be used.

<Acrylate>

Examples of the acrylate used in the preparation of (7) the alternating copolymer of the specific monomer and the acrylate of the present invention include straight, branched or cyclic alkyl acrylates having 1 to 20 carbon atoms, such as methyl acrylate, 2-ethylhexyl acrylate, and cyclohexyl acrylate, heterocyclic group-containing acrylates having 2 to 20 carbon atoms, such as glycidyl acrylate and 2-tetrahydrofurfuryl acrylate, aromatic cyclic group-containing acrylates having 6 to 20 carbon atoms, such as benzyl acrylate, and acrylates having a polycyclic structure of 7 to 30 carbon atoms, such as isobornyl acrylate and dicyclopentanyl acrylate.

In the present invention, in order to obtain (7) the alternating copolymer of the specific monomer and the acrylate, when the sum of the specific monomer and the acrylate is defined as 100 mol, the radical polymerization is usually conducted at a ratio of 30 mol to 70 mol of the specific monomer and 70 to 30 mol of the acrylate, preferably 40 mol to 60 mol of the specific monomer and 60 mol to 40 mol of the acrylate, particularly preferably 45 mol to 55 mol of the specific monomer and 55 mol to 45 mol of the acrylate in the presence of Lewis acid.

The amount of Lewis acid used to obtain (7) the alternating copolymer of the specific monomer and the acrylate is in a range of 0.001 mol to 1 mol based on 100 mol of the acrylate.

Furthermore, a publicly known organic peroxide which generates free radicals or an azobis-based radical polymerization initiator may be used, and the polymerization reaction temperature is usually −20° C. to 80° C., preferably 5° C. to 60° C. Further, in the solvent for the polymerization reaction, the same solvent as the solvent used for the ring-opening polymerization reaction may be used.

Alternatively, the “alternating copolymer” referred to in the present invention means a copolymer having a structure in which structural units derived from the specific monomer are not adjacent to each other, that is, a structural unit derived from the specific monomer is necessarily adjacent to a structural unit derived from the acrylate, and does not deny a structure wherein structural units derived from the acrylates are present adjacent to each other.

For the preferred molecular weight of the cyclic olefin-based resin used in the present invention, the number average molecular weight (Mn) in terms of polystyrene as measured by gel permeation chromatography (GPC) is 12,000 to 100,000, more preferably 16,000 to 80,000, and particularly preferably 20,000 to 50,000. The weight average molecular weight (Mw) of the cyclic olefin-based resin is preferably 40,000, more preferably 40,000 to 300,000, even more preferably 60,000 to 250,000, and particularly preferably 80,000 to 200,000.

As the number average molecular weight and the weight average molecular weight are in the ranges, water resistance, chemical resistance, and mechanical characteristics of the cyclic olefin-based resin and molding processability as an optical film become good.

(Measurement of Molecular Weight)

The weight average molecular weight (Mw) and molecular weight distribution (Mw/Mn) in terms of standard polystyrene were measured by using GPC: gel permeation chromatography device (HLC-8220 manufactured by Tosoh Corp., columns; guard column HXL-H manufactured by Tosoh Corp., TSK gel G7000HXL, 2 TSK gel GMHXLs, and TSK gel G2000HXL were subsequently connected, eluent; tetrahydrofuran, flow rate; 1 mL/min, sample concentration; 0.7 wt % to 0.8 wt %, sample injection amount; 70 μL, measurement temperature; 40° C., detector; RI (40° C.), and standard material; TSK standard polystyrene manufactured by Tosoh Corp.). Alternatively, Mn is a number average molecular weight in terms of standard polystyrene.

[Layer A]

Layer A is a layer including the aforementioned cyclic olefin-based resin, but the preferred content of the cyclic olefin-based resin is 50 mass % or more, more preferably 65 mass % to 100 mass %, and even more preferably 80 mass % to 100 mass %, based on the total mass of Layer A.

[Layer B]

Layer B is a layer including a cyclic olefin-based resin, and contains a rubber elastomer having a carbon-carbon double bond which forms no aromatic ring in an amount of 2.5 mass % or more based on the total mass of Layer B. From the viewpoint of reducing the internal haze of the film obtained, the rubber elastomer is contained in an amount of 50 mass % or less based on the total mass of Layer B, and from the viewpoint that the internal haze of the film is low and adhesion with the polarizer is excellent, the rubber elastomer is contained in an amount of preferably 5 mass % to 40 mass % and more preferably 10 mass % to 25 mass % based on the total mass of Layer B.

The preferred content of the cyclic olefin-based resin in Layer B is 50 mass % or more, more preferably 65 mass % to 97.5 mass %, and even more preferably 80 mass % to 97.5 mass %, based on the total mass of Layer B.

(Content of Polymer of Compound Represented by Formula (I) in Layer B)

The polymer of the compound represented by Formula (I) is contained in an amount of preferably 40 mass % or more based on the total mass of the cyclic olefin-based resin to be contained in Layer B.

The polymer of the compound represented by Formula (I) is contained in an amount of more preferably 60 mass % to 100 mass %, and even more preferably 85 mass % to 100 mass % based on the total mass of the cyclic olefin-based resin to be contained in Layer B.

(Content of Polymer of Compound Represented by Formula (F) in Layer B)

The polymer of the compound represented by Formula (F) is contained in an amount of preferably 40 mass % or more based on the total mass of the cyclic olefin-based resin to be contained in Layer B.

When the content of the polymer of the compound represented by Formula (F) is 40 mass % or more, the haze of the film obtained, particularly, the internal haze of the film may be further reduced. The polymer of the compound represented by Formula (F) is contained in an amount of more preferably 60 mass % to 100 mass %, and even more preferably 85 mass % to 100 mass % based on the total mass of the cyclic olefin-based resin to be contained in Layer B.

[Rubber Elastomer Having Carbon-Carbon Double Bond which Forms No Aromatic Ring]

The term “carbon-carbon double bond which forms no aromatic ring” means excluding carbon-carbon double bonds included in an aromatic ring among the carbon-carbon double bonds. As the rubber elastomer, a rubber elastomer, which is a polymer, is preferred, a rubber elastomer having a carbon-carbon double bond which forms no aromatic ring in the main chain is more preferred, and a rubber elastomer containing a repeating unit represented by the following Formula (B) is even more preferred.

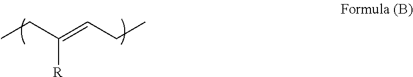

In Formula (B), R represents a hydrogen atom or a methyl group.

R is preferably a hydrogen atom.

In the present invention, the rubber elastomer to be contained in Layer B is not particularly limited as long as the rubber elastomer has a carbon-carbon double bond which forms no aromatic ring, and a core-shell particle or a rubber polymer may be used.

In the present invention, it is preferred that an optical film is produced using a solution film formation method, but the rubber elastomer to be contained in the composition which forms Layer B may have a carbon-carbon double bond which forms no aromatic ring to make the solubility and dispersibility in solution excellent and reduce the haze of the film obtained, particularly, the internal haze of the film.

<Core-Shell Particle>

In the present invention, core-shell particles may be used as the rubber elastomer. The core-shell particles have an alternating layer formed of two kinds of polymers (core and one shell) or two or more kinds of polymers (core and one or more shells) among various polymers. The overall characteristics of these particles are that each layer is composed of polymers having different glass transition temperatures Tg. In the present specification, a polymer having a low glass transition temperature refers to a rubber phase to become a core, and a polymer having a high glass transition temperature refers to a hard phase to become a shell. This type of particle may be prepared by, for example, emulsion polymerization. The core-shell particles may be chemically cross-linked when one or more layers are prepared, such that the type and size of the core-shell particle are not changed during the blending.

Since the particle diameters are not changed by using crosslinking-type core-shell particles during the film formation, the particle diameters of the core-shell particles present in a film are easily controlled.

An uncrosslinked base material which may be used for the crosslinked rubber phase is a polymer-based base material having a glass transition temperature of less than 0° C., preferably less than −20° C., and particularly preferably less than −40° C. A suitable polymer is essentially all the polymers which have this type of glass transition temperature and are suitable for the synthesis of core-shell particles.

The rubber phase glass transition temperatures may not be individually measured in many cases, but may be determined by preparing an emulsion polymer of monomer compositions associated, isolating the polymer, and subsequently measuring the glass transition temperature. A separate method of measuring the rubber phase glass transition temperature is measuring dynamic mechanical characteristics of a new polymer blend and dynamic mechanical characteristics of a single matrix polymer. The maximum value of the dynamic loss curves (mechanical loss factor curves) may be considered as a measure of the glass transition temperature.

The rubber phase present in the core-shell particles suitable for the object of the present invention is present in an amount of 10 vol % to 90 vol %, preferably 20 vol % to 70 vol %, and particularly preferably 30 vol % to 60 vol % based on the total volume of the particles.

The hard phase present in the core-shell particles suitable for the object of the present invention is present in an amount of 90 vol % to 10 vol %, preferably 80 vol % to 30 vol %, and particularly preferably 70 vol % to 40 vol % based on the total volume of the particles.

The preparation of the core-shell particles is publicly known, and the details thereof are described in, for example, U.S. Pat. Nos. 3,833,682 and 3,787,522, German Patent Application Nos. DE-A-2116653, DE-A-2253689, DE-A-4132497, and DE-A-4040986, U.S. Pat. No. 3,125,1904, and German Patent Application No. DE-A-3300526.

A polymer used as the rubber phase of the core-shell particles may be homopolymers or copolymers composed of two or more monomers.

The homopolymers or copolymers of the present specification may be derived from the following monomers:

conjugated diene monomers (for example, butadiene, isoprene, and chloroprene), monoethylenically unsaturated monomers, for example, alkyl and arylacrylates (provided that the alkyl group may be linear, cyclic, or branched, and the aryl group may have a substituent itself), alkyl and arylmethacrylates (provided that the alkyl group may be linear, cyclic, or branched, and the aryl group may have a substituent itself), substituted alkyl and arylmethacrylate and acrylates (provided that the substituent may be linear, cyclic, or branched, or a substituted alkyl group or a substituted aryl group), acrylonitrile and substituted acrylonitriles (for example, methacrylonitrile, α-methylene glutaronitrile, α-ethyl acrylontrile, and α-phenyl acrylonitrile), alkyl- and arylacrylamides and substituted alkyl- and arylacrylamides, vinyl ester and substituted vinyl esters, vinyl esters and substituted vinyl esters, vinyl amides and substituted vinyl amides, vinyl ketones and substituted vinyl ketones, halogenated vinyls and substituted halogenated vinyls, for example, olefins having one or more double bonds used for preparing olefinic rubber, particularly, ethylene, propylene, butylene and 1,4-hexadiene, and vinyl aromatic compounds (for example, styrene, α-methyl styrene, vinyl toluene, halostyrenes and tert-butylstyrenes).

In addition, a rubber phase, which adopts organopolysiloxanes represented by the following Formula (II) as a base, may also be used for the preparation of core-shell particles.

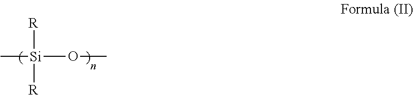

In Formula (II), R is an alkyl or alkenyl group, an aryl group or a substituted hydrocarbon group having 1 to 10 carbon atoms, which are same or different. Alternatively, the alkyl group and the alkenyl group may be linear, branched, or cyclic.

It is also possible to use a rubber phase which adopts a fluorinated monoethylenically unsaturated compound, for example, tetrafluoroethylene, vinylidene fluoride, hexafluoropropene, chlorotrifluoroethylene and perfluoro (alkyl vinyl) ethers, and the like as a base.

The rubber phase may be crosslinked, and for the use of the rubber phase, it is also possible to prepare a polyfunctional unsaturated compound as described in German Patent Application No. DE-A-116653, No. U.S. Pat. No. 3,787,522, and European Patent Application No. EP-A-0436080. These publications also describe the use of grafting monomers (grafting-on monomers). These compounds may be further used to chemically crosslink the shell to the following phase, if desired.

In the present invention, when core-shell particles are used as the rubber elastomer, the rubbed phase forming the core is composed of a compound having a carbon-carbon double bond which forms no aromatic ring, but in particular, it is preferred that the rubber phase of the rubber elastomer is core-shell particles having repeating units derived from butadiene.

The polymer, which may be used as the hard phase of the core-shell particles, is homo- or copolymers. In the present specification, the copolymers may be composed of two or more monomers. The characteristic, which is common for suitable homo- and copolymers, is a glass transition temperature of 50° C. or more.

In the present specification, the homo- and copolymers may be derived from the following monomers:

monoethylenically unsaturated compounds, for example, alkyl and arylacrylates (provided that the alkyl group may be linear, cyclic, or branched, and the aryl group may have a substituent itself), alkyl and arylmetharylates (provided that the alkyl group may be linear, cyclic, or branched, and the aryl group may have a substituent itself), substituted alkyl and arylmethacrylate and acrylates (provided that the substituent may be linear, cyclic, or a substituted alkyl group or a substituted aryl group), acrylonitrile and substituted acrylonitriles (for example, methacrylonitrile, α-methylene glutaronitrile, α-ethyl acrylontrile, and α-phenyl acrylonitrile), alkyl- and arylacrylamides, vinyl ester and substituted vinyl esters, vinyl ethers and substituted vinyl ethers, vinyl amides and substituted vinyl amides, vinyl ketones and substituted vinyl ketones, halogenated vinyls and substituted halogenated vinyls, olefins (for example, ethylene, propylene, and butylene), cyclic olefins (for example, norbornene, tetracyclododecene, and 2-vinyl norbornene), fluorinated monoethylenically unsaturated compounds, for example, tetrafluoroethylene, vinylidene fluoride. hexafluoropropene, chlorotrifluoroethylene and perfluoro (alkyl vinyl) ethers, and a vinyl aromatic compound represented by the following Formula (III).

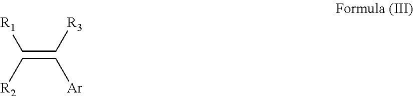

In Formula (III), R₁, R₂, and R₃ may be same as or different, and are hydrogen or a linear, branched or cyclic alkyl group, and Ar is a C₆ to C₁₈ aromatic group which may have an additional substituent, for example, an alkyl or halogen group, and the like.

The hard phase may be crosslinked, and for the present purpose, it is also possible to prepare a polyfunctional unsaturated compound as described in German Patent Application No. DE-A-2116653, U.S. Pat. No. 3,787,522, and European Patent Application No. EP-A-0436080. These publications also describe the use of grafting monomers. These compounds may be further used to chemically crosslink the shell to the following phase, if desired.

The polymer, which is an uncrossed base material, has a glass transition temperature of 50° C. or more, preferably 80° C. or more, and particularly preferably 100° C. or more.

As the rubber elastomer included in the Layer B in the present invention, it is possible to use commercially available core-shell particles, for example, Staphyloid grades from TAKEDA Chem. Industries. described, for example, in Japanese Patent No. 17514 or 129266, Kane-Ace grades from KANEKA, described in the Knae ACE-B product brochure, Metablen C, Metablen W and Metablen E grades from METABLEN Company BV, described in the Metablen product brochure, Blendex grades manufactured by GE PLASTICS or Paraloid grades manufactured by ROHM and HAAS, described, for example, in Gachter/Muller Kunststoff-Additive [Plastics Additives], Carl Hanser, Munich (1983) pages XXIX et seq. or in the PARALOID BTA733 brochure, Impact Modifiers for Clear Packaging (1987) from Rohm and Haas or in the PARALOIDBTA-IIIN2BTA-702 BTA 715 brochure (1989) from Rohm and HaasCarl Hanser.

Alternatively, it is preferred that as the form of the core-shell particles, core-shell particles (MBS) adopting butadiene as a core and at least one of styrene and methylmethacrylate (more preferably, the ratio of styrene is 10 mol % or more, and even more preferably 30 mol % or more) as a shell are used.

When core-shell particles are used as the rubber elastomer included in the Layer B of the present invention, the content of the core-shell particles is 2.5 mass % to 50 mass %, preferably 5 mass % to 40 mass %, and more preferably 10 mass % to 25 mass % based on the total mass of Layer B. When the content of the core-shell particles is 2.5 mass % or more, the adhesion between the film and the polarizer may be improved, and when the content is 50 mass % or less, a haze of the film, particularly, an internal haze of the film is low.

<Rubber Elastomer>

In the present invention, a rubber polymer may be used as the rubber elastomer. The rubber polymer is a polymer having a glass transition temperature of 40° C. or less. A rubber or thermoplastic elastomer is included in the rubber polymer. In the case where are two or more glass transition temperatures as in block copolymers, the polymer may be used when the lowest glass transition temperature is 40° C. or less. The Mooney viscosity (ML1+4,100° C.) of the rubber polymer is appropriately selected, and is usually 5 to 300.

Examples of the rubber polymer include a diene-based rubber such as a random copolymer of polybutadiene, polyisoprene, and styrene with butadiene or isoprene, an acrylonitrile-butadiene copolymer, a butadiene-isoprene copolymer, a butadiene-(meth)acrylic acid alkyl ester-acrylonitrile copolymer, and a butadiene-(meth)acrylic acid alkyl ester-acrylonitrile-styrene copolymer, a butylene-isoprene copolymer, an aromatic vinyl-conjugated diene-based block copolymer such as a styrene-butadiene block copolymer, a hydrogenated styrene-butadiene block copolymer, a hydrogenated styrene-butadiene random copolymer, a styrene-isoprene block copolymer, and a hydrogenated styrene-isoprene block copolymer, a low crystalline polybutadiene resin. and the like.

Alternatively, it is preferred that as the rubber polymer, a styrene-butadiene-styrene block copolymer (SBS) is used.

The particle diameter of the rubber elastomer is preferably 10 nm to 500 nm, more preferably 50 nm to 300 nm, and even more preferably 50 nm to 100 nm.

When the particle diameter of the rubber elastomer is 10 nm or more, the adhesion between the film and the polarizer is excellent, and when the particle diameter is 500 nm or less, a haze of the film, particularly, an internal haze of the film is low.

The weight average molecular weight of the rubber elastomer is preferably 50,000 to 200,000, more preferably 50,000 to 150,000, and even more preferably 50,000 to 100,000. When the weight average molecular weight of the rubber elastomer is 50,000 or more, adhesion with the polarizer is excellent, and when the weight average molecular weight is 200,000 or less, the haze is low.

The weight average molecular weight of the rubber elastomer is measured by the same method as in the weight average molecular weight of the above-described cyclic olefin-based resin.

In the present invention, the rubber elastomer is added in a specific amount to the cyclic olefin-based resin included in Layer B, so that when an optical film is adhered to a polarizer, and then the optical film is intended to be peeled off from the polarizer, stress dispersion is generated, and it became difficult to apply stress thereto, and thus, it becomes difficult for peeling between Layer A and Layer B to be generated, and as a result, adhesion between the optical film and the polarizer may be improved.

(Polarizer Peel Force)

The film of the present invention has a polarizer peel force of preferably 3 N or more, more preferably 6 N or more, and even more preferably 10 N or more. By adjusting the polarizer peel force to 3 N or more, the adhesion with the polarizer becomes excellent and the yield in the processing of the polarizing plate is improved.

It is preferred that the film thickness of Layer A and Layer B of the optical film used in the present invention has a relationship that Layer A is thicker than Layer B. The preferred film thickness of the entire layer is in a range of preferably 2.5 μm to 100 μm, and in particular, the preferred film thickness for an image display device is preferably 2.5 μm to 80 mun and more preferably 2.5 μm to 50 μm. The ratio of the film thickness of Layer B to the film thickness of the entire layer is preferably 0.1% to 40%, more preferably 0.1% to 20%, and particularly preferably 0.1% to 10%. By setting the ratio to the range, the dimensional stability of the laminated film may be compatible with adhesion with a polarizer at high temperature.

The thickness of Layer A is preferably 2.0 μm to 90 μm, more preferably 2.0 μm to 70 pun, and even more preferably 2.0 μm to 40 μm.

Alternatively, in the present invention, the thickness of Layer B is set to less than 10 μm. The thickness of Layer B is preferably 0.5 μm to 8 μm, more preferably 0.5 μm to 5 μm. and even more preferably 0.5 μm to 3 μm. By setting the thickness of Layer B to less than 10 μm, the haze of the laminated film obtained, the internal haze of the film may be reduced.

In the present invention, it is preferred that Layer A and Layer B are directly laminated, but Layer A and Layer B may be joined by an adhesive, and the like. As a method for directly laminating Layer A and Layer B, there is a method for simultaneously casting Layer A and Layer B on a metal support, or a method for casting any one layer and then subsequently casting the other layer, as the method described in Japanese Patent Laid-Open Publication No. H11-198285. Alternatively, a film on only one layer is prepared, and then application or casting may be performed on the layer to provide a layer. A layer of each of Layer A and Layer B may be laminated, and three layers or more as in Layer B-Layer A-Layer B may be laminated. When three or more layers are laminated, it is preferred that at least one outermost layer is allowed to be Layer B.

It is preferred that the optical film of the present invention has a first Layer B and a second Layer B as Layer B, and a first Layer B, Layer A, and a second Layer B in this order. The first Layer B and the second Layer B may be same or different.

[Additives]

It is possible to add various additives (for example, a plasticizer, a retardation (optically anisotropic) adjusting agent, a UV absorber, a matting agent, an antioxidant, a peeling accelerator, and the like) to the optical film of the present invention depending on the use in each preparation process. These additives may be solids and oils. That is, the melting point or boiling point thereof is not particularly limited. For example, ultraviolet absorption materials may be mixed at 20° C. or less and 20° C. or less, or deterioration inhibitors may be equally mixed, and the like. Further, with respect to the time for adding the additive, the additive may be added anywhere in the process of preparing a cyclic olefin-based resin solution, but a dope preparation process may be further carried out by adding the additive to the final preparation process of the dope preparation process. In addition, the amount of each material added is not particularly limited as long as the function is exhibited. Furthermore, with respect to the Layer A and the Layer B, which have the optical film of the present invention, the kinds or amounts of additives added to each layer may be different.

From the viewpoint of improving adhesion with the polarizer, it is preferred to include a compound having a molecular weight of 10,000 or less in at least one of Layer A and Layer B.

Hereinafter, each additive will be described.

(Plasticizer)

Plasticizers have a function of controlling physical properties of the optical film of the present invention, or improving the fluidity or flexibility of a dope solution of a cyclic olefin-based resin dissolved in a solvent when a plasticizer is added to the dope solution. Examples of the additives include phthalic acid ester-based, aliphatic acid ester-based, trimellitic acid ester-based, phosphoric acid ester-based, polyester-based, or epoxy-based plasticizers, and the like.

(Retardation Adjusting Agent)

A retardation adjusting agent may be added to the optical film of the present invention. As a retardation adjusting agent in the present invention, it is possible to preferably use any one of a retardation adjusting agent which develops retardation (hereinafter, also referred to as a retardation developer) and a retardation adjusting agent which decreases retardation (hereinafter, also referred to as a retardation decreasing agent).

(UV Absorber)

Examples of a UV absorber include benzotriazole-based, 2-hydroxybenzophenone-based, or salicylic acid phenyl ester-based UV absorbers, and the like. For example, it is possible to exemplify triazoles such as 2-(5-methyl-2-hydroxyphenyl)benzotriazole, 2-[2-hydroxy-3,5-bis(α,α-dimethylbenzyl)phenyl]-2H-benzotriazole, and 2-(3,5-di-t-butyl-2-hydroxyphenyl)benzotriazole, and benzophenones such as 2-hydroxy-4-methoxybenzophenone, 2-hydroxy-4-octoxybenzophenone, and 2,2′-dihydroxy-4-methoxybenzophenone.

(Matting Agent)

It is preferred that the optical film of the present invention contains a matting agent from the viewpoint of the film sliding properties and the stable preparation. The matting agent may be a matting agent of an inorganic compound or a matting agent of an organic compound.

As a specific preferred example of the matting agent of the inorganic material, an inorganic compound including silicon (for example, silicon dioxide, fired calcium silicate, hydrated calcium silicate, aluminum silicate, magnesium silicate, and the like), titanium oxide, zinc oxide, aluminum oxide, barium oxide, zirconium oxide, strontium oxide, antimony oxide, tin oxide, tin oxide.antimony, calcium carbonate, talc, clay, fired kaolin, calcium phosphate, and the like are preferred, and an inorganic compound including silicon or zirconium oxide is more preferred, but silicon dioxide is particularly preferably used because silicon dioxide may reduce the turbidity of a cellulose acylate film. As the silicon dioxide particle, it is possible to use a commercially available product having a trade names such as, for example, Aerosil R972, R974, R812, 200, 300, R202, OX50, and TT600 (all manufactured by NIPPON AEROSIL CO., LTD.). As the zirconium oxide particles, it is possible to use a commercially available product under the trade name such as, for example, AEROSIL R976 and R811 (all manufactured by NIPPON AEROSIL CO., LTD.).

As a specific preferred example of the matting agent of the organic compound, for example, a silicone resin, an acrylic resin, and the like are preferred. Among the silicon resins, particularly, a silicone resin having a three-dimensional mesh type structure is preferred, and it is possible to use a commercially available product under the trade name such as, for example, Tospearl 103, Tospearl 105, Tospearl 108, Tospearl 120, Tospearl 145, Tospearl 3120 and Tospearl 240 (all manufactured by Toshiba Silicone Co.).

When these matting agents are added to a cyclic olefin-based resin solution, the method thereof is not particularly limited, and does not matter as long as a desired cyclic olefin-based resin solution may be obtained by any method. For example, an additive may be contained in the step of mixing a cyclic olefin-based resin with a solvent, or the additive may be added after the cyclic olefin-based resin and the solvent are mixed to produce a mixed solution. Furthermore, the additive may be added and mixed immediately before a dope is cast, and the method is a so-called just-in-time addition method, and the mixing is used by providing a screw-type kneading on line. Specifically, a static mixer such as an in-line mixer is preferred, and as the in-line mixer, an in-line mixer such as, for example, a static mixer SWJ (Toray static in-tube mixer Hi-Mixer) (manufactured by Toray Engineering Co., Ltd.) is preferred. Alternatively, with respect to the in-line addition, in order to remove concentration unevenness, aggregation of particles, and the like, Japanese Patent Laid-Open Publication No. 2003-053752 describes an invention of removing concentration unevenness and aggregation of matting particles and the like in a method of manufacturing a cyclic olefin-based resin film, in which the distance L between the end of an addition nozzle through which an addition solution with a different composition is added to a main raw material dope, and a starting end of the in-line mixer is set to 5 times or less the inner diameter d of a pipe for feeding a main raw material. As a more preferred aspect, it is described that the distance L between the end opening of a feeding nozzle through which an addition solution with a composition different from the main raw material dope is added, and the starting end of the in-line mixer is set to 10 times or less the inner diameter d of the end opening of the feeding nozzle, and the in-line mixer is a static non-agitation-type in-tube mixer or a dynamic agitation-type in-tube mixer. More specifically, it is disclosed that the ratio of flow rate of a main raw material dope of the cellulose acylate film/the in-line addition solution) is 10/1 to 500/1, and preferably 50/1 to 200/1. Further, Japanese Patent Laid-Open Publication No. 2003-014933, which is an invention directed to a phase difference film which is low in bleed-out of additives, free from inter-layer peeling, good in sliding properties, and excellent in transparency, also describes that as a method of adding an additive, the additive may be added to a dissolving pot, an additive or a solution having the additive dissolved or dispersed therein may be added to the dope being fed from the dissolving pot to a co-casting die, but in the latter case, a mixing unit such as static mixer is preferably provided in order to enhance mixing performance.

(Antioxidant)

An antioxidant may be suitably added as long as the antioxidant is a compound which prevents oxidation or degradation and thermal decomposition or thermal coloration when the cyclic olefin-based resin of the present invention is molded or used in the film. It is possible to expect the effect by adding an antioxidant which is each suitable as a mechanism of action, which captures or decomposes alkyl radical or peroxide radical produced by the oxidation of resins. For example, IRGANOX-1010 and IRGANOX-1076 manufactured by BASF, SUMILIZERGM and SUMILIZERGS manufactured by Sumitomo Chemical Co., Ltd., and the like may be exemplified.

The aforementioned additives may be used either alone or in combination of two or more thereof.

(Production Method of Film)

As a method for producing the optical film in the present invention, a solution film formation method is preferred. Thermal decomposition may be suppressed because heating and melting at high temperature are not required for film-forming a resin having a high Tg. Further, surface smoothness is easily obtained by leveling of the solvent.

(Solvent)

Solvents which dissolve the cyclic olefin-based resin will be described. As the solvent, an organic solvent is preferably used. In the present invention, an available organic solvent is not particularly limited as long as the object thereof may be achieved in a range where a cyclic olefin-based resin is dissolved and cast, and may form a film. As the organic solvent used in the present invention, for example, a chlorine-based solvent such as dichloromethane and chloroform, and a solvent selected from chain hydrocarbons, cyclic hydrocarbons, aromatic hydrocarbons, esters, ketones, ethers, and alcohols are preferred. The esters, ketones, ethers, and alcohols may have a cyclic structure. Examples of the chain hydrocarbons include hexane, octane, isooctane, decane, and the like. Examples of the cyclic hydrocarbons include cyclopentane, cyclohexane, decalin, and derivatives thereof. Examples of the aromatic hydrocarbons include benzene, toluene, xylene, and the like. Examples of the esters include ethyl formate, propyl formate, pentyl formate, methyl acetate, ethyl acetate, and pentyl acetate. Examples of the ketones include acetone, methyl ethyl ketone, diethyl ketone, diisobutyl ketone, cyclopentanone, cyclohexanone, and methylcyclohexanone. Examples of the ethers include diisopropyl ether, dimethoxymethane, dimethoxyethane, 1,4-dioxane, 1,3-dioxolane, tetrahydrofuran, anisole, and phenetole. Examples of an organic solvents having two or more functional groups include 2-ethoxyethyl acetate, 2-methoxy ethanol, and 2-butoxy ethanol. Examples of the alcohols include methanol, ethanol, 1-propanol, 2-propanol, n-butanol, iso-butanol, tert-butanol, and the like. The preferred boiling point of the organic solvent is 35° C. to 200° C. As the solvent, one solvent may be used alone, or a mixture of two or more thereof at any ratio may be used.

In addition, in a range where the solubility may be maintained, it is also preferred that a representative solvent having a polar group such as a carbonyl group and a hydroxyl group is used in combination with ester, ketone, ether, alcohol, and the like. By using the solvent having polarity in combination, the peel load may be reduced from a metal support used for casting, and productivity may be improved.

(Dope Concentration)

The concentration of the solid content of the dope prepared using the solvent is preferably 10 wt % to 40 wt %, and also preferably 15 wt % to 35 wt %. When the concentration is higher than the range, the load is increased during the dope filtration, so that the productivity is reduced. Further, when the dope is discharged from a die, the dope is easily attached to the die lip, thereby being easily responsible for appearance of stripes.

(Dissolution Method)

Examples of a method for dissolving the cyclic olefin-based resin include a method according to the stirring and dissolution at room temperature, a cooling dissolution method in which the resin is stirred at room temperature to swell the polymer, and then the polymer is cooled from −20° C. to −100° C., and again heated from 20° C. to 100° C. and dissolved, a high temperature-dissolution method of dissolving the resin by heating the resin to a temperature which is equal to or more than the boiling point of the main solvent in a hermetically sealed vessel, and furthermore, a method for dissolving the resin by maintaining the temperature and pressure at the critical point of the solvent. For polymers having good solubility, the room temperature dissolution is preferred, but for polymers having poor solubility, the resin is heated and dissolved in a hermetically sealed vessel. It is preferred to select a temperature as low as possible for polymers having intermediate solubility because thermal decomposition of the resin is suppressed, or the process load is reduced.

(Filtration)

For the dope, it is preferred that undissolved matters, or foreign matters such as dusts and impurities are removed by filtration using a suitable filter material such as metal mesh or flannel prior to casting. For the filtration of the dope, a filter having an absolute filtration accuracy of 0.1 μm to 100 μm is used, and a filter having an absolute filtration accuracy of 0.5 μm to 25 μm is preferably used. As the filter material, publicly known materials in the related art, such as glass fiber, cellulose fiber, filter paper, and a fluororesin such as a tetrafluoroethylene resin may be preferably used, and ceramics, metal, and the like are also preferably used.

(Viscosity)

The viscosity of the dope immediately before the film formation may be in a range where the dope may be cast during the film formation, and usually, the dope is prepared in a range of preferably 1 Pa*s to 200 Pa-s, more preferably 3 Pa*s to 100 Pa*s, and even more preferably 5 Pa*s to 70 Pa*s. Alternatively, the temperature in this case is not particularly limited as long as the temperature is a temperature during the casting of the dope, but is preferably −5° C. to 70° C., more preferably −5° C. to 40° C.

(Film Formation)

The method for producing a film using a cyclic olefin-based resin solution will be described. As the method and apparatus for producing the optical film of the present invention, there are used a solution film formation method and a solution casting film formation device, which are the same as those provided for producing the cellulose triacetate film in the related art. A dope (cyclic olefin-based resin solution) prepared from a dissolution machine (pot) is once stored in a storage pot, and a final preparation is carried out therein by removing bubbles included in the dope. The dope is transported from a dope outlet to a pressure type die through, for example, a pressure type metering gear pump capable of transporting a constant amount of solution with high precision according to the number of revolutions, and uniformly cast on a metal support endlessly running from an anvil (slit) of the pressure type die, and an insufficiently dried dope film (also called web) is peeled off from the metal support at a peeling point where the metal support travels nearly one round. While both ends of the produced web are fixed by clips, the web is conveyed to a tenter to be dried, subsequently conveyed to a roll group of a drying device to complete the drying, and wound to a predetermined length by a winding machine. The combination of the tenter and the drying apparatus including a roll group varies depending on the purpose. In the solution casting film formation method used for a functional protective film for a display, in addition to the solution casting film formation device, a coating device is added in some cases in order to to apply surface treatment to the film, such as an undercoat layer, an antistatic layer, an antihalation layer and a protective layer. Hereinafter, each production process will be simply described, but the present invention is not limited thereto.

First, when an optical film is produced by a solvent cast method, it is preferred that the prepared cyclic olefin-based resin solution (dope) is cast on an endless metal support, for example, a metal drum or a metal support (band or belt), and a film is formed by evaporating the solvent. The dope before casting is preferably adjusted such that the amount of the cyclic olefin-based resin becomes 10 mass % to 40 mass %. It is preferred that the surface of the drum or the band is finished to have a specular state. The dope is preferably cast on a drum or a band having a surface temperature of 30° C. or less, and particularly, the temperature of the metal support is preferably −10° C. to 20° C.

Further, it is possible to apply the cellulose acylate film-formation technology described in Japanese Patent Laid-Open Publication Nos. 2000-301555, 2000-301558, H7-032391, H3-193316, H5-086212, S62-037113, H2-276607. S55-014201, H2-111511, and H2-208650 to the present invention.

(Casting)

As a method for casting a solution, there are a method of uniformly extruding a prepared dope from a pressure die onto a metal support, a method using a doctor blade in which a dope once cast onto a metal support is subjected to a blade to adjust the thickness, or a method using a reverse roll coater for adjusting the thickness by means of a reversely rotating roll, but a method using a pressure die is preferred. The pressure die includes a coat hunger type or a T-die type, and the like, but all the types may be preferably used. In addition, besides the methods exemplified herein, various methods for casting a cellulose triacetate solution to form a film known in the related art may be performed, and the same effects as described in each publication are obtained by establishing each condition in consideration of differences in boiling point of a solvent to be used, and the like. As a metal support which runs endlessly used for producing the optical film of the present invention, a drum whose surface has been specular finished by chromium plating or a stainless steel belt (which may also be referred to as a band) whose surface has been specular finished by surface abrasion is used. For the pressure die used for producing the optical film of the present invention, one or two or more pressure die(s) may be provided above the metal support. Preferably, one or two pressure die(s) is/are provided. In the case of providing two or more pressure dies, the amount of a dope to be cast may be separated into various portions for each die, or the dope may be fed to each die in each portion from a plurality of accurately metering gear pumps. The temperature of the cyclic olefin-based resin solution used for casting is preferably −10° C. to 55° C., more preferably 25° C. to 50° C. In that case, the temperature may be the same throughout the entire process, or may be different among each place of the process. When the temperatures are different, it is sufficient for the temperature to be at a desired level immediately before casting.

(Simultaneous or Subsequent Casting Process)

It is preferred that the production method of the present invention includes the process of simultaneously or subsequently casting a dope including a cyclic olefin-based resin (A) and a cope containing a rubber elastomer having a carbon-carbon double bond which forms no aromatic ring with the cyclic olefin-based resin in an order of (B) to (A) from a casting substrate side on a casting substrate.

In the method for preparing an optical film according to the present invention, it is preferred that at least two of the dopes for an outer layer and the dopes for a core layer are co-cast on the casting substrate in this order from the casting substrate side.

(Drying on Support)

With respect to drying of the dope on the metal support according to production of the optical film, there are generally a method of applying a hot air from the surface side of a metal support (for example, a drum or a band), i.e., from the surface of the web on the metal support, a method of applying a hot air from the back surface of a drum or a band, and a liquid heat transfer method in which a temperature-controlled liquid is brought into contact with the back surface of the band or drum opposite to the dope-cast surface to heat the drum or band by heat transfer, but the back surface liquid heat transfer system is preferred. The surface temperature of the metal support before casting may be any temperature as long as the temperature is equal to or less than the boiling point of a solvent used for the dope. However, in order to accelerate drying and lose fluidity on the metal support, the temperature is preferably set at a level lower than the boiling point of the solvent having the lowest boiling point among the solvents used by 1° C. to 10° C.

(Peeling from Metal Support)

When peel resistance (peel load) is large at the time when an insufficiently dried film is peeled off from a metal support, the film is irregularly stretched in a direction of film formation to generate an optically anisotropic unevenness. Particularly, in the case where the peel load is large, portions where the film is stepwise stretched and portions where the film is not stretched in the direction of film formation are alternately formed and a distribution in retardation occurs. When the film is mounted on a liquid crystal display device, linear or band-like unevenness is observed. In order to prevent such a problem from occurring, it is preferred to adjust the peel load of the film to 0.25 N or less per 1 cm of film peel width. The peel load is more preferably 0.2 N/cm or less, and even more preferably 0.15 N/cm or less. When the peel load is 0.2 N/cm or less, no unevenness due to the peel is observed even on a liquid crystal display device where unevenness is apt to appear, so that the case is particularly preferred. As the method of reducing the peel load, there are a method of adding a peeling agent as described above and a method of selecting a solvent composition to be used.

The peel load is measured in the following manner. A dope is dropped on a metal plate having the same material and the same surface roughness as those of the metal support in the film-forming device, and is spread to a uniform thickness using a doctor blade, followed by drying. Notches are formed with uniform width in the film using a cutter knife, the end of the film is peeled off by hand and gripped by a clip connected to a strain gauge, and the change in load is measured while the strain gauge is drawn up in an inclined direction of 45°. The content of volatile components in the peeled film is also measured. The same measurement is repeated several times by changing the drying period to determine the releasing load when the content of the residual volatile components is the same as that at the time of peeling in the actual film-forming process. As the peeling speed increases, the peel load tends to become larger, and the measurement is preferably conducted at a peeling speed approximate the actual peeling speed.

The concentration of residual volatile components at the time of peeling is preferably 5 mass % to 100 mass %, more preferably 10 mass % to 60 mass %, and particularly preferably 15 mass % to 40 mass %. When peeling is conducted at a stage where the content of volatile components is at a high level, the drying speed is increased, and thus, the productivity is improved, which is preferred. Meanwhile, when peeling is conducted at a stage where the content of volatile components is at a high level, the film has a small strength or elasticity and may be broken or elongated with yielding to the peel force. In addition, the self-retaining force of the film after peeling is insufficient and the film is liable to suffer from deformation and generation of wrinkles and crevices. Furthermore, insufficient self-retaining force is responsible for generation of distribution in retardation.

(Drying)

A method of drying a web dried and peeled on a drum or a belt will be described. It is preferred that a web peeled off at a peeling point immediately before the drum or the belt travels one round is conveyed by a method in which the web is conveyed while alternately passing through a roll group disposed in a zigzag type, or a method in which the peeled web is conveyed in a non-contact manner while both ends thereof are gripped by clips and the like.

For the production method of the present invention, in the moving portion from the peeling process to the stretching process, the film passes through preferably 3 or more pass rolls, more preferably 5 or more pass rolls, and 7 to 51 pass rolls at a lap angle of at least 60°. Further, it is preferred that the production method of the present invention includes at least one dancer as the pass roll at a lap angle of 600 or more as described above, and the number of dancers provided is preferably 1. Alternatively, the lap angle in the present specification means the size of central angle at which a circumferential region where the film laps the roll is connected to the roll center, and for example, when the film passes through the roll disposed in a complete zigzag type, the lap angle becomes 180°.

The drying is conducted by a method in which air at a predetermined temperature is applied to both surfaces of the web (film) being conveyed or a method using a heating unit such as microwave oven, and the like. Since there is concern in that rapid drying may impair the surface smoothness of the film, it is preferred that the film is dried at a temperature as not to generate foaming of the solvent in the initial stage of drying, the drying is conducted, and then the drying is conducted at high temperature. In the drying process after the web is peeled off from the support, the film is liable to shrink in a longitudinal direction or a width direction by evaporation of the solvent. The higher the temperature is, the more higher the film shrinks. It is preferred that the film is dried while the shrinkage is suppressed as much as possible in view of improving the surface smoothness of the finished film. In this regard, as shown in, for example, Japanese Patent Laid-Open Publication No. S62-46625, preferred is a method (tenter system) in which the entire process or a portion of the drying is carried out while both width ends of the web are maintained by clips or pins in a width direction. The drying temperature in the drying process is preferably 100° C. to 160° C. The drying temperature, drying air amount, drying time are different, but may be appropriately selected according to the kinds and combinations of solvents used.

(Stretching)

In the production of the film of the present invention, it is possible to include a process of stretching a web (film) peeled off from the support. When the film of the present invention is used as a phase difference film, the phase difference may be adjusted by including the stretching process.

The method of stretching the web is not particularly limited. Examples thereof include a method of stretching the web in a conveying direction by imparting a peripheral velocity difference to a plurality of rolls, and using the roll peripheral velocity difference in the meantime, a method of stretching the web in a conveying direction by fixing both ends of the web by clips or pins, and widening the intervals of the clips or pins in a direction orthogonal to the conveying direction, or a method of simultaneously stretching the web both in a conveying direction and in a width direction by simultaneously widening the web lengthwise and widthwise, an inclinedly stretching method of conveying the web in an inclined direction while being gripped. Needless to say, these methods may be used in combination. Further, the so-called tenter method is preferred because when the clip part is driven by a linear drive system, a smooth stretching may be conducted, and a risk such as fracture may be reduced. As the stretching is performed, expression properties of the retardation may be adjusted.

(Winding)

It is preferred that winding is conducted while the optical film is dried, and the content of the residual volatile components is maintained at 1% or less. It is preferred that knurling is performed at both ends of the film before being wound. The width of knurling is 3 mm to 50 mm, and more preferably 5 mm to 30 mm, and the height is 1 μm to 50 μm, preferably 2 μm to 20 μm, and more preferably 3 μm to 10 μm. One side may be pressed, or both sides may be pressed.

The width of the optical film obtained as described above is preferably 0.5 m to 3 m, more preferably 0.6 m to 2.5 m, and even more preferably 0.8 m to 2.2 m. With respect to the length, the film is wound at a length of 100 m to 10,000 m, more preferably 500 m to 7.00 m, and even more preferably 1,000 m to 6,000 m per roll. At the time of winding, it is preferred that knurling is imparted to at least one end, the width is 3 mm to 50 mm, and more preferably 5 mm to 30 mm, and the height is 0.5 μm to 500 μm, and more preferably 1 μm to 200 μm. One side may be pressed. or both sides may be pressed. In a winding machine which winds the obtained film, a winding machine generally used may be used, and the film may be wound by a winding method such as a constant tension method, a constant torque method, a taper tension method, and an internal stress constant program tension control method.

The optical film of the present invention is used as a protective film of a polarizer. In this case, the optical film of the present invention is used as a protective film at a liquid crystal cell side of a liquid crystal display device with respect to a polarizer, and may be allowed to have a function as a so-called an optically-compensatory film (or a phase difference film) which compensates the inclined viewing angle of the liquid crystal cell. Meanwhile, the optical film of the present invention may also be used as a protective film at the external side with respect to the polarizer rather than the liquid crystal cell. The optically-compensatory film refers to an optical material which is generally used in a liquid crystal display device, and thus, compensates the phase difference, and has the same meaning as a phase difference plate, an optically-compensatory sheet, and the like. The optically-compensatory film is used for the purpose of having the birefringence, removing the coloration of the display screen of a liquid crystal display device, or improving the viewing angle characteristics.

Re and Rth:

In the optical film of the present invention, it is preferred that for the retardation in an in-plane direction Re(590) at a wavelength of 590 nm, 30 nm<Re(590)<100 nm, and for the retardation in a film thickness-direction at a wavelength of 590 nm Rth(590), 80 nm<Rth(590)<300 nm. For Re(590), 30 nm<Re(590)<100 nm is preferred, and 40 nm<Re(590)<80 nm is more preferred. In addition, Rth(590) preferably satisfies 80 nm<Rth(590)<300 nm, and more preferably 80 nm<Rth(590)<150 nm.

Here, Re and Rth are values defined in the following Equation (I) and Equation (II).

Re=(nx−ny)×d(nm) Equation (1)

Rth={(nx+ny)/2−nz}×d(nm) Equation (II)

(in the equations, nx is a refractive index of the film in an in-plane slow axis direction, ny is a refractive index of the film in an in-plane fast axis direction, nz is a refractive index of the film in a thickness direction, and d is the thickness (nm) of the film.

Re(λ) and Rth(λ) each indicate an in-plane retardation and a retardation in a thickness-direction at a wavelength λ. In the specification of the present application, the wavelength λ is set to 590 nm when there is no particular description. Re is measured by making a light having a wavelength of λ nm incident in the normal direction of the film in KOBRA21ADH (manufactured by Oji Scientific Instruments Co., Ltd.). Rth(λ) is calculated by means of KOBRA21ADH based on retardation values obtained by measuring the Re(λ) in total 6 points by making an incident light of nm in wavelength incident in the direction inclined at an angle stepwise varying, by 10°, up to 500 at one side from the normal line direction with respect to the normal line direction of the film with taking the slow axis in plane (determined by KOBRA21ADH) as an inclination axis (rotation axis)(in the case where there is no slow axis, any direction in film plane being taken as the rotation axis), an assumed value of average refractive index, and the inputted film thickness value. Furthermore, the Rth may also be calculated in following Equations (A) and (B) based on retardation values obtained by measuring in any two directions with taking the slow axis as an inclination axis (rotation axis) (in the case where there is no slow axis, any direction in film plane being taken as the rotation axis), an assumed value of average refractive index, and the inputted film thickness value. Here, as for the assumed value of average refractive index, values described in Polymer Handbook (JOHN WILEY & SONS, INC.) and catalogues of various optical films may be used. A value of average refractive index that has not yet been known may be measured by means of an Abbe refractometer. Values of average refractive index of main optical films will be exemplified below: cellulose acylate (1.48), cycloolefin polymer (1.52), polycarbonate (1.59), polymethyl methacrylate (1.49), and polystyrene (1.59). KOBRA 21ADH calculates nx, ny, and nz by inputting the assumed value of average refractive index and the film thickness. Based on the calculated nx, ny and nz, Nz=(nx−nz)/(nx−ny) is again calculated.

$$Re ( θ ) = \begin{matrix}[ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \\ \frac{d}{cos \{ {sin}^{- 1} ( \frac{sin ( - θ )}{nx} ) \}}\end{matrix} \qquad Equation ( A )$$

Here, the Re(θ) indicates a retardation value in a direction tilted by an angle θ from a normal line direction. d indicates thickness of the film.

Rth=((nx+ny)/2−nz)×d Equation (B)

Alternatively, in this case, the average refractive index n becomes necessary as a parameter, but a value obtained by measurement with an Abbe refractometer (“Abbe refractometer 2-T” manufactured by ATACGO CO., LTD.) may be used.

(Irregularity of Optical Properties)

When the optical film of the present invention is used as a phase difference film, the irregularity of the polarization performance after the processing of the polarizing plate may be reduced by reducing the irregularity of optical properties. When the in-plane retardation of the phase difference film is defined as Re and the retardation in a thickness direction is defined as Rth, the irregularity of the Re value of the entire width is preferably ±5 nm, and more preferably ±3 nm. Further, the irregularity of the Rth value is preferably ±10 nm, more preferably ±5 nm, and particularly preferably ±3 nm. In addition, it is preferred that irregularities of the Re value and the Rth value in the longitudinal direction are also within the range of the irregularities in the width direction. In the optical film roll obtained as described above, the slow axis direction of the film is preferably ±2° with respect to the winding direction (longitudinal direction of the film), and also preferably in a range of ±1°. Alternatively, a direction (width direction of the film) vertical to the winding direction is preferably ±2°, and also preferably in a range of ±1°. In particular, the slow axis direction of the film is preferably within ±0.3° with respect to the winding direction (longitudinal direction of the film). Alternatively, the slow axis direction of the film is preferably within ±0.3° with respect to the width direction of the film.

(Internal Haze)

The film of the present invention has an internal haze of preferably 0.1% or less, more preferably 0.06% or less, and even more preferably 0.04% or less. By adjusting the internal haze to 0.1% or less, the contrast (display performance) of a display device is excellent.

(Functional Layer)

In the optical film of the present invention, a functional layer having a film thickness of 0.1 μm to 20 μm may be further laminated on at least one surface of the film. The kind of functional layer is not particularly limited, but examples thereof include a hardcoat layer, an antireflection layer (a layer in which the refractive index is adjusted, such as a low-refractive index layer, an intermediate-refractive index, and a high-refractive index layer), an antiglare layer, an antistatic layer, a UV absorption layer, a moisture permeability reduction layer, and the like. For the functional layer, one layer may be provided, and plural layers may be provided. A method for laminating the functional layer is not particularly limited, but it is preferred that the functional layer is provided by co-casting with the cyclic olefin-based resin composition for forming the optical film of the present invention, and it is also preferred that the functional layer is provided while being coated on the optical film of the present invention.

Furthermore, in order to prepare an antireflection layer (a layer in which the refractive index is adjusted, such as a low-refractive index layer, an intermediate-refractive index, and a high-refractive index layer), an antiglare layer, an antistatic layer, a UV absorption layer, a moisture permeability reduction layer, and the like as the functional layer, various additive materials may also be added to materials for the functional layer.

The thickness of the functional layer is more preferably 0.01 μm to 100 μm, and particularly preferably 0.02 μm to 50 μm. Further, as a functional layer for reducing the moisture permeability layer, a layer having a thickness of 0.1 μm to 20 μm is more particularly preferred.

(Surface Treatment)

The optical film of the present invention may be subjected to surface treatment in some cases to achieve improvement in adhesion with a layer (for example, a polarizer, an undercoat layer, and a back layer) different from the film. For example, a glow discharge treatment, a UV irradiation treatment, a corona treatment, a flame treatment, and an acid or alkali treatment may be used. The glow discharge treatment herein referred to may be a low temperature plasma caused under a low pressure gas of 10⁻³ Torr to 20 Torr, and further preferably a plasma treatment under an atmospheric pressure. The plasma excitation gas refers to a gas that is excited into plasma under the conditions as described above, and examples thereof include argon, helium, neon, krypton, xenon, nitrogen, carbon dioxide, flons such as tetrafluoromethane, mixtures thereof, and the like. Details thereof are described in detail on page 30 to page 32 of the Journal of Technical Disclosure (Kogi No. 2001-1745, issued on Mar. 15, 2001, Japan Institute of Invention and Innovation), and these treatments may be preferably used in the present invention.

[Polarizing Plate]

A polarizing plate using the optical film of the present invention includes at least one of the optical film of the present invention as a protective film and at least one layer of a polarizer, and it is preferred that Layer B is disposed so as to be at the polarizer side in joining the optical film to the polarizer. In addition, in joining the optical film of the present invention to the liquid crystal cell, the function of the optically-compensatory film may be possessed by disposing the optical film at the cell side rather than the polarizer, and the polarizer may also be at the cell side. Furthermore, the present invention may have a multilayer configuration in which the above-described functional layer or the surface treatment is provided on the surface of the optical film of the present invention.

When another polarizing plate protective film is used in the polarizing plate having at least one of the optical film of the present invention, a suitable transparent film may be used as a film. In particular, a cellulose acetate-based film, an acrylic film, a polyethylene terephthalate (PET) film, and the like may be preferably used.

When the polarizing plate of the present invention has a configuration of having two or more optical films of the present invention, each film may be the same optical film, or an optical film different from each other.

In the method for producing a polarizing plate, the polarizing plate may be prepared by a general method. Examples thereof include a method of joining the optical film of the present invention to the liquid crystal cell by subjecting the surface at the side of the Layer B of the optical film of the present invention is subjected to corona treatment, and using a completely saponified polyvinyl alcohol aqueous solution in both surfaces of the polarizer prepared by immersing and stretching a polyvinyl alcohol film in an iodine solution. Instead of the corona treatment, an easy adhesion process as described in Japanese Patent Laid-Open Publication Nos. H6-94915 and H6-118232 may also be performed. Further, a surface treatment such as the above-described alkali treatment may also be performed.

Examples of an adhesive used to join a polarizing plate protective film-treated surface to a polarizer include a polyvinyl alcohol-based adhesive such as polyvinyl alcohol and polyvinyl butyral, or a vinyl-based latex such as butyl acrylate, a UV curable adhesive, a thermally curable adhesive, and the like.

The optical film of the present invention and the polarizer may be joined to each other via another adhesive or tackifier, and may be directly laminated without intervening an adhesive or tackifier in a range in which there is no practical problem such as peeling.

The characteristics of a polarizing plate using the optical film of the present invention may be adjusted depending on the characteristics of the optical film of the present invention or another polarizing plate protective film which is simultaneously used, if necessary. For example, when a warpage is produced on the polarizing plate, it is also preferred to each adjust the film thickness of the optical film of the present invention or another polarizing plate protective film in order to prevent the warpage.

(Image Display Device)

An image display device of the present invention is characterized to include the optical film of the present invention and a polarizing plate using the optical film of the present invention. The image display device of the present invention may be preferably used in a liquid crystal display device or an organic EL display, and the like. As the liquid crystal display device, a VA system or an IPS system is known, and as the use, the optical film of the present invention and a polarizing plate using the same may be preferably used over various aspects such as large-sized televisions, monitors for a personal computer, laptop personal computers, medium and small-sized tablet PCs, and mobile phones.

### EXAMPLES

Hereinafter, the present invention will be described in more detail with reference to the Examples. Materials, use amounts, proportions, processing contents, processing procedures and the like shown in the following Examples may be appropriately modified as long as the modification does not deviate from the gist of the present invention. Therefore, the scope of the present invention is not limited to the following specific examples.

### Synthesis of Cyclic Olefin-Based Resin

### Synthesis Example 1

Into a reaction vessel substituted with nitrogen, 100 parts by mass of 8-methyl-8-methoxycarbonyltetracyclo[4.4.0.1^{2,5}.1^{7,10}]-3-dodecene, 4.6 parts by mass of 1-hexene of a molecular weight modifier, and 200 parts by mass of toluene were injected and heated to 80° C. 0.18 ml of a toluene solution of triethyl aluminum (0.6 mol/L) and 0.58 ml of a toluene solution (0.025 mol/L) of methanol modified WCl₆, were added thereto and reacted at 80° C. for 3 hours to obtain a polymer. Subsequently, the resulting ring-opening copolymer solution was put into an autoclave, and 200 parts by mass of toluene was again added thereto. A hydrogenation catalyst RuHCl(CO)[P(C₆H₅)]₃ was added in an amount of 2,500 ppm to an amount of monomer injected, and a reaction was performed under a hydrogen gas pressure of 9 to 10 MPa at 160° C. to 165° C. for 3 hours. After the reaction was terminated, the product was precipitated in a large amount of a methanol solution to obtain a hydrogen added product (Resin 1). The obtained hydrogen added product of the ring-opening polymer was found to have a weight average molecular weight (Mw)=135×10³ and a molecular weight distribution (Mw/Mn)=3.1.

### Synthesis Examples 2 to 4

Resins 2 to 4 were obtained in the same manner as in Synthesis Example 1, except that 100 parts by mass of the monomer 8-methyl-8-methoxycarbonyltetracyclo[4.4.0.1^{2,5}.1^{7,10}]-3-dodecene and 4.6 parts by mass of 1-hexene were changed into the monomer and the injection amount described in the following Table 1.

TABLE 1

| | 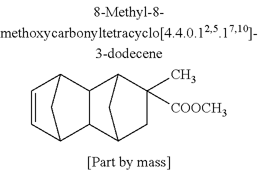 [SMILES: COC(=O)C1(C)CC2CC1C1C3C=CC(C3)C21] | 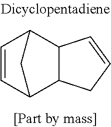 | 1-Hexane [Part by mass] |
|---|---|---|---|
| Resin 1 | 100.0 | 0.0 | 4.6 |
| Resin 2 | 80.4 | 19.6 | 5.3 |
| Resin 3 | 54.0 | 46.0 | 6.2 |
| Resin 4 | 30.5 | 69.5 | 7.0 |

### Example 1

### Preparation of Dope for Layer A

As a dope for Layer A, Resin 1 obtained in Synthesis Example 1 was dissolved in methylene chloride to prepare a solution having a concentration of solid content of 25 mass %.

### Preparation of Dope for Layer B

### Preparation of Dispersion

Methylene chloride was added to a core-shell particle (MBS particle) in which Kane Ace M732 (manufactured by Kaneka Corporation): butadiene was used as a core and methyl methacrylate-styrene was used as a shell so as to have a solid content of 5 mass %, the mixture was dispersed in a dispersing machine, and a dispersion was prepared.

### Preparation of Dope

As a dope for Layer B, Resin 1 obtained in Synthesis Example 1 and the dispersion prepared above was added such that Kane Ace M732 became 10 parts by mass with respect to the resin, and methylene chloride was again added thereto to prepare a solution having a concentration of solid content of 25 mass %.

### Stretching, Drying

Next, casting was conducted on a metal support through a casting geeser capable of 3 layer co-casting. In this case, casting was conducted such that the layer configuration became Layer B, Layer A, and Layer B in this order from the metal support surface side. In this case, the conditions were set such that the film thickness of Layer A and the film thickness of Layer B were 38 μm and 1 μm, respectively. While being on the metal support, the dope was dried by drying air at 40° C. to form a film, the film was peeled, both ends of the film were fixed by clips, and dried by drying air at 120° C. for 5 minutes while maintaining the space therebetween at the same interval. The clips were removed, and then the film was again dried at 150° C. for 20 minutes to obtain Film 1, which is the optical film of the present invention.

### Examples 2 to 12 and Comparative Examples 1 to 6

Films 2 to 18 were obtained in the same manner as in Example 1, except that the resins used in Layer A and Layer B, the kind of rubber elastomer, the amount of rubber elastomer added, and the film thickness were changed into those described in Table 2. Alternatively, when a rubber elastomer other than MBS particles was used, a dope was prepared by dissolving the rubber elastomer in methylene chloride in the same manner as in the resins without preparing the dispersion.

Alternatively, as the rubber elastomer to be added to the dope for Layer B, a rubber elastomer described below were used.

Core-shell particle (MBS particle) in which Kane Ace M732 (manufactured by Kaneka Corporation): butadiene was used as a core and methyl methacrylate was used as a shell

Styrene ratio 15 mol %, Particle diameter 70 nm

Asaprene T439 (manufactured by Asahi Kasei Chemicals Corporation): Styrene-Butadiene-Styrene Block Copolymer (SBS)

Styrene ratio 45 mol %, Weight average molecular weight 64,000

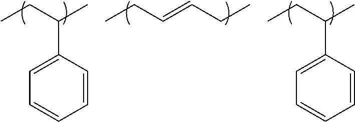

Quintac3450 (manufactured by Nippon Zeon Co., Ltd.): Styrene-Isoprene-Styrene Block Copolymer (SIS) Styrene ratio 19 mol %, Weight average molecular weight 192,000

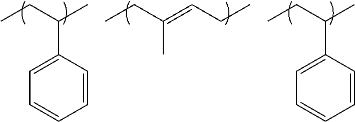

Tuftec H-1051 (manufactured by Asahi Kasei Chemicals Corporation): Styrene-Ethylene-Butylene-Styrene Block Copolymer (SEBS)

Styrene ratio 42 mol %, Weight average molecular weight 73,000

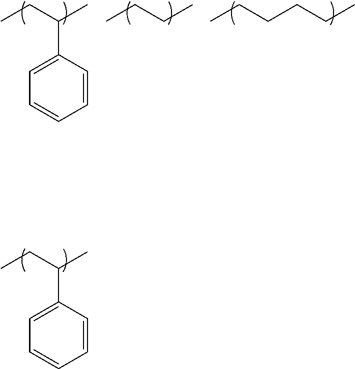

<Evaluation of Internal Haze>

The internal haze of the optical film was measured by a method in accordance with JISK-7136; specifically, the following method.

A haze meter (type: NDH2000, manufactured by Denshoku Industries Co., Ltd.) was prepared. The light source was a 5V9W halogen bulb, and the light receiving portion was a silicon photo-cell (equipped with a relative visibility filter).

1) Measurement of Blank Haze

On a cleaned slide glass, a drop (0.05 ml) of liquid paraffin was dropped. In this case, care was taken to prevent bubbles from entering the liquid droplet.

Subsequently, a cover glass was put on the dropped liquid paraffin. Even though the cover glass was not pressed down, the liquid paraffin was spread.

Accordingly, the resulting sample for blank measurement (cover glass/liquid paraffin/slide glass) was mounted on a haze meter to measure Haze 1 (blank haze).

2) Measurement of Haze of Sample Including Optical Film

Liquid paraffin was dropped on a slide glass cleaned in the same manner as in 1).

Meanwhile, an optical film to be measured was humidity controlled at 23° C. and 55% RH for 5 hours. Subsequently, the humidity-controlled optical film on the dropped liquid paraffin was lifted so as to prevent bubbles from entering therein.

Further, 0.05 ml of liquid paraffin was dropped on the optical film, and then the cover glass was again lifted.

Accordingly, the obtained sample for measurement (cover glass/glycerin/sample film/liquid paraffin/slide glass) was mounted on the above-described haze meter to measure Haze 2.

3) Haze 1 obtained in 1) and Haze 2 obtained in 2) were applied to the following equation to calculate the haze of the optical film.

Internal Haze of Optical Film (%)=Haze 2(%)−Haze 1(%)

The reason for evaluating the internal haze is because when a polarizing plate shape is employed, the surface haze is joined to a polarizer or a cell and disappears, and it is the internal haze that substantially contributes to the contrast (display performance).

<Evaluation of Peel Force>

(Production of Polarizer)

A polyvinyl alcohol film having a thickness of 75 μm, composed of a polyvinyl alcohol having an average polymerization degree of about 2,400 and a saponification degree of 99.9 mol % or more was immersed in pure water at 30° C., and then immersed in an aqueous solution of iodine/potassium iodide/water of 0.02/2/100 as a mass ratio. And then, the film was immersed in an aqueous solution of potassium iodide/boric acid/water of 12/5/100 as a mass ratio at 56.5° C.

Subsequently, the film was cleaned with pure water at 8° C., and then dried at 65° C. to obtain a polarizer in which iodine was adsorbed and oriented on a polyvinyl alcohol film. Stretching was mainly conducted during the process of dyeing with iodine and boric acid treatment, and the total stretching ratio was 5.3 times.

(Preparation of Water-Based Adhesive)

An acetoacetyl group modified polyvinyl alcohol (Gohsefimer Z-200 manufactured by Nippon Synthetic Chemical Industry Co., Ltd., viscosity of a 4% aqueous solution=12.4 mPa·sec, saponification degree=99.1 mol %) was dissolved in pure water, and an aqueous solution having a concentration of 10% was prepared. An aqueous solution of the acetoacetyl group modified polyvinyl alcohol and a crosslinking agent sodium glyoxylate were mixed such that the mass ratio of the solid content of the former:the latter became 1:0.1, and was again diluted with pure water such that the acetoacetyl group modified polyvinyl alcohol became 2.5 parts with respect to 100 parts of water, thereby preparing an adhesive composition.

(Joining)

On the external layer sides of Optical Films 1 to 18, corona discharge irradiation was conducted under a condition of 400 W-min/m² using VE1A-A manufactured by VETAPHONE Co., Ltd., and each of the optical film was joined to one surface of the polarizer using the water-based adhesive prepared above. A saponification-treated triacetyl cellulose film was joined to the other surface of the polarizer.

The saponification-treated triacetyl cellulose film was prepared as follows. FUJITAC TD80UL (manufactured by Fuji Photo Film Co., Ltd.) was immersed in 4.5 mol/L of an aqueous sodium hydroxide solution (saponification liquid) which had been temperature-controlled at 37° C. for 1 minutes, the film was washed with water, and then immersed in 0.05 mol/L of an aqueous sulfuric acid solution, and allowed to pass through a water bath. And then, dehydration by an air knife was repeated three times to remove water, and then the film was stayed for drying in a drying zone at 70° C. for 15 seconds to prepare a saponification-treated triacetyl cellulose film.

(Evaluation of Peel Force)

The surface of the optical film of the prepared polarizing plate was subjected to corona treatment, and then an acrylic adhesive sheet was joined to the corona treated surface. The obtained tackifier attached polarizing plate was cut into a test specimen having a width of 25 mm and a length of about 200 mm, the tackifier surface thereof was joined to soda glass, and then the pressurization treatment was performed in an autoclave at a pressure of 5 kgf/cm² and a temperature of 50° C. for 20 minutes, and the specimen was again left to stand under an atmosphere of a temperature of 23° C. and a relative humidity of 60% overnight. In this state, the triacetyl cellulose film and the polarizer at one end (one side having a width of 25 mm) of the test specimen in a longitudinal direction were gripped using a tensile tester (RTF-1210 manufactured by A&D Co., Ltd.) and subjected to a 90-degree peel test (in accordance with JISK6854-1:1999 “Adhesives-Determination of peel strength of bonded assemblies—Part 1: 90° peel”) under an atmosphere of a temperature of 23° C. and a relative humidity of 60% at a crosshead speed (grip moving speed) of 200 mm/min, and the result of evaluating the peel force between the optical film and the polarizer is shown in Table 2. With respect to the fact that the optical film and the polarizer were not peeled off, the peel forces thereof exceeded the measurement upper limits, and thus, was recorded as >10 (N/25 mm).

TABLE 2

| | | | | | | | | | Film thickness | | |
|---|---|---|---|---|---|---|---|---|---|---|---|
| | | | Layer B | | | | | | configuration (μm) | | |
| | | | | Content of | | | Addition | Particle | Layer B (Polarizer | Internal | Polarizer |
| | | Layer A | | Formula (F) | Rubber | | amount | diameter | side)/Layer | haze | peel force |
| | | Polymer | Polymer | (% by mass) | elastomer | Form | (% by mass) | (nm) | A/Layer B | (%) | (N/25 mm) |
| Ex. 1 | Film 1 | Resin 1 | Resin 1 | 100 | Kane Ace | MBS | 5 | 70 | 1/38/1 | 0.01 | 6 |
| | | | | | M732 | particle | | | | | |
| Ex. 2 | Film 2 | Resin 1 | Resin 1 | 100 | Kane Ace | MBS | 10 | 70 | 1/38/1 | 0.03 | >10 |
| | | | | | M732 | particle | | | | | |
| Ex. 3 | Film 3 | Resin 1 | Resin 1 | 100 | Kane Ace | MBS | 20 | 70 | 1/38/1 | 0.05 | >10 |
| | | | | | M732 | particle | | | | | |
| Ex. 4 | Film 4 | Resin 1 | Resin 1 | 100 | Kane Ace | MBS | 30 | 70 | 1/38/1 | 0.09 | >10 |
| | | | | | M732 | particle | | | | | |
| Ex. 5 | Film 5 | Resin 1 | Resin 1 | 100 | Kane Ace | MBS | 10 | 70 | 5/30/5 | 0.09 | >10 |
| | | | | | M732 | particle | | | | | |
| Ex. 6 | Film 6 | Resin 1 | Resin 1 | 100 | Kane Ace | MBS | 10 | 70 | 0.5/39/0.5 | 0.01 | 3 |
| | | | | | M732 | particle | | | | | |
| Ex. 7 | Film 7 | Resin 1 | Resin 1 | 100 | Asaprene | SBS | 10 | 100 | 1/38/1 | 0.03 | 4 |
| | | | | | T439 | | | | | | |
| Ex. 8 | Film 8 | Resin 1 | Resin 2 | 70 | Kane Ace | MBS | 10 | 70 | 1/38/1 | 0.04 | 7 |
| | | | | | M732 | particle | | | | | |
| Ex. 9 | Film 9 | Resin 1 | Resin 3 | 40 | Kane Ace | MBS | 10 | 70 | 1/38/1 | 0.05 | 8 |
| | | | | | M732 | particle | | | | | |
| Ex. 10 | Film 10 | Resin 1 | Resin 4 | 20 | Kane Ace | MBS | 10 | 70 | 1/38/1 | 0.09 | >10 |
| | | | | | M732 | particle | | | | | |
| Ex. 11 | Film 11 | Resin 1 | Resin 1 | 100 | Quintac | SIS | 10 | 150 | 1/38/1 | 0.09 | >10 |
| | | | | | 3450 | | | | | | |
| Ex. 12 | Film 12 | Resin 1 | Resin 1 | 100 | Kane Ace | MBS | 5 | 70 | 1/39/0 | 0.01 | 6 |
| | | | | | M732 | particle | | | | | |
| C. Ex. 1 | Film 13 | Resin 1 | — | | — | — | — | — | —/40/— | 0.01 | 1 |
| C. Ex. 2 | Film 14 | — | Resin 1 | 100 | Kane Ace | MBS | 10 | 70 | —/—/40 | 0.30 | >10 |
| | | | | | M732 | particle | | | | | |
| C. Ex. 3 | Film 15 | — | Resin 1 | 100 | Asaprene | SBS | 10 | 100 | —/—/40 | 0.30 | 4 |
| | | | | | T439 | | | | | | |
| C. Ex. 4 | Film 16 | Resin 1 | Resin 1 | 100 | Kane Ace | MBS | 2 | 70 | 1/38/1 | 0.01 | 2 |
| | | | | | M732 | particle | | | | | |
| C. Ex. 5 | Film 17 | Resin 1 | Resin 1 | 100 | Kane Ace | MBS | 10 | 70 | 10/20/10 | 0.15 | 6 |
| | | | | | M732 | particle | | | | | |
| C. Ex. 6 | Film 18 | Resin 1 | Resin 1 | 100 | Tuftec | SBS | 10 | 400 | 1/38/1 | 0.22 | 3 |
| | | | | | H-1051 | | | | | | |

The optical films in the Examples had low internal hazes and excellent adhesion with the polarizer.

The film in Comparative Example 1 is composed of only Layer A, and adhesion with the polarizer was poor. The films in Comparative Examples 2 and 3 were composed of only Layer B, and the internal hazes were high. Since the content of the rubber elastomer in Layer B in the film in Comparative Example 4 was lower than those of the films in the Examples, adhesion with the polarizer was low. Since Layer B of the film in Comparative Example 5 was thicker than those of the films in the Examples, the internal haze was increased. Since the rubber elastomer in the film in Comparative Example 6 did not have a carbon-carbon double bon which forms no aromatic ring, the internal haze was higher than those of the films in the Examples.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and there equivalents.

What is claimed is:

1. An optical film comprising:
a Layer A containing a cyclic olefin-based resin, and
a Layer B disposed on at least one surface of the Layer A and containing a cyclic olefin-based resin,
wherein the Layer B contains a rubber elastomer having a carbon-carbon double bond that forms no aromatic ring in an amount of 2.5 mass % or more based on a total mass of the Layer B, and
a thickness of the Layer B is less than 10 μm.

2. The optical film according to claim 1,
wherein the cyclic olefin-based resin contained in the Layer B contains a polymer of a compound represented by the following Formula (I) in an amount of 40 mass % or more based on a total mass of a cyclic olefin-based resin contained in the Layer B: 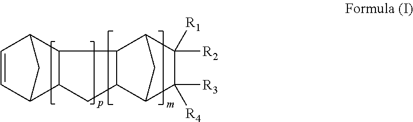
wherein in Formula (I), R₁ to R₄ are a hydrogen atom, a halogen atom, or a monovalent organic group and are each optionally same or different, and two of R₁ to R₄ optionally combine with each other to form a monocyclic or polycyclic structure,
m is 0 or a positive integer, and
p is 0 or a positive integer.

3. The optical film according to claim 2,
wherein the polymer of the compound represented by Formula (I) is hydrogenated after ring-opening polymerization of the compound represented by Formula (I).

4. The optical film according to claim 1,
wherein the rubber elastomer contains a repeating unit represented by the following Formula (B): 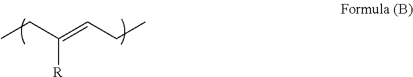
wherein in Formula (B), R represents a hydrogen atom or a methyl group.

5. The optical film according to claim 1,
wherein the rubber elastomer is a particle having a core-shell structure.

6. The optical film according to claim 1,
wherein the Layer B is disposed on both surfaces of the Layer A.

7. The optical film according to claim 1,
wherein the Layer A has a thickness of 2 μm to 90 μm.

8. A polarizing plate comprising the optical film according to claim 1 and a polarizer.

9. The polarizing plate according to claim 8,
wherein the Layer B of the optical film is joined to the polarizer.

10. An image display device comprising a liquid crystal cell and the polarizing plate according to claim 8 disposed on at least one surface of the liquid crystal cell.
